(19) United States
(12) Patent Application Publication
(10) Pub. No.: US 2025/0034332 A1
(43) Pub. Date: Jan. 30, 2025

(54) POLYESTER POLYCARBONATE POLYOL

(71) Applicant: ASAHI KASEI KABUSHIKI KAISHA, Tokyo (JP)

(72) Inventors: Kosuke SENDA, Tokyo (JP); Tetsuo MASUBUCHI, Tokyo (JP)

(73) Assignee: ASAHI KASEI KABUSHIKI KAISHA, Tokyo (JP)

(21) Appl. No.: 18/699,997

(22) PCT Filed: Nov. 1, 2022
(86) PCT No.: PCT/JP2022/040872

§ 371 Date: Apr. 10, 2024

(30) Foreign Application Priority Data
Nov. 4, 2021 (JP) 2021-180342

(51) Int. Cl. C08G 64/02; C08G 18/44; C08G 18/76; D06N 3/12

(52) U.S. Cl. CPC C08G 64/0208; C08G 18/44; C08G 18/7657; D06N 3/121

(57) ABSTRACT

A polyester polycarbonate polyol having a repeating unit represented by specific formula (1) and a repeating unit represented by specific formula (2), having a hydroxyl value of 35 to 85 mgKOH/g, having a hydroxyl group at a terminal, and being in the form of a liquid at ordinary temperature.

### TECHNICAL FIELD

The present invention relates to a novel polyester polycarbonate polyol.

### BACKGROUND ART

Synthetic leather favorable in flexibility has been conventionally obtained by coating a fibrous base material or a film-forming plate with a solution of a polyurethane resin obtained by polymerization with polyester polyol such as polypropylene glycol or polytetramethylene glycol, and coagulating the solution in water. Although having excellent flexibility, such synthetic leather is easily decomposed due to a component such as sweat and is problematic in terms of durability. There is also synthetic leather obtained by coagulating a solution of a polyurethane resin obtained by polymerization with polyester polyol obtained by reacting a hydroxy compound and a dibasic acid. This synthetic leather is problematic in terms of hydrolysis resistance.

For example, Patent Document 1 discloses synthetic leather obtained from a polyurethane resin obtained by polymerization with polycarbonate diol, as synthetic leather for solving the above problems. Patent Document 1 specifically discloses a porous sheet-shaped article obtained by allowing a urethane composition including a polyurethane formed from a polycarbonate diol, an organic isocyanate and a low molecular diol, and a polyurethane formed from a polyester-based diol, an organic diisocyanate and a low molecular diol to be incorporated or connected into a fiber base material and/or onto a fiber base material.

Patent Document 2 discloses a porous sheet material obtained by a wet film-forming method involving providing a solution of a polyurethane resin formed from a high molecular diol, an organic isocyanate and, if necessary, a chain elongating agent, to a substrate. The porous sheet material is characterized in that the high molecular diol is a mixed diol of a polycarbonate diol and a polyester diol, the polycarbonate diol is a copolymerized polycarbonate diol which includes 1,4-butanediol and one or more of other alkane diols each having 4 to 6 carbon atoms, which contains 50 to 90% by mol of 1,4-butanediol based on the total molar number of the diol and which has a number average molecular weight of 500 to 5000, and the coagulation value of the polyurethane resin is 7 to 14.

Patent Document 3 discloses a surface film layer of synthetic leather, obtained by using a polyurethane resin including a polyester polycarbonate polyol obtained by a transesterification reaction of an aliphatic oligocarbonate diol obtained by a transesterification reaction of an aliphatic diol and a dialkyl carbonate, and a polyester polyol obtained by ring-opening addition polymerization of a cyclic ester compound with a compound having an active hydrogen group as an initiator, and a polyisocyanate and a chain extender.

Patent Document 4 discloses a porous sheet material obtained by wet coagulation, characterized in that the porous sheet material is obtained by reacting a high molecular diol including an polycarbonate diol (a1) formed from an alkane diol having 4 or more and 6 or less carbon atoms and a polycarbonate diol (a2) formed from an alkane diol having 7 or more and 12 or less carbon atoms, both the polycarbonate diols being copolymerized polycarbonate diols and the percentages by weight of (a1) based on the total weight of (a1) and (a2) being 10% or more and 80% or less, an organic isocyanate and a chain elongating agent.

Patent Document 5 discloses synthetic leather including a surface layer and a fiber cloth, in which the surface layer is formed from a surface layer material-forming composition for fiber laminates, the composition includes a main agent and a curing agent, the main agent is a polycarbonate diol obtained from 1,6-hexanediol and a low molecular carbonate, the curing agent includes a modified polyisocyanate (B1) of hexamethylene diisocyanate, having a number average molecular weight of 350 to 500 and an average number of functional groups (f) of 2≤f<3, and an isocyanurate-modified polyisocyanate (B2) of hexamethylene diisocyanate, having an average number of functional groups of f≥3, the (B1):(B2) equals to 50:50 to 95:5 (weight ratio), and both the main agent and the curing agent contain no organic solvent.

Patent Document 6 proposes synthetic leather formed of a specific polycarbonate diol (copolymerized polycarbonate diol derived from 1,5-pentanediol and 1,6-hexanediol) in order to provide synthetic leather which has excellent balance of physical properties such as sweat resistance and flexibility and furthermore which causes no crack or wrinkle during storage.

Patent Document 7 discloses a polyurethane adhesive in which a polyester carbonate diol having an ester bond and a carbonate bond in its molecule is used in order to improve low-temperature flexibility of a polycarbonate diol, and provides the description in which the diol to be used is mainly 3-methyl-1,5-pentanediol, or a mixed diol thereof with a linear alkylene glycol having 6 to 10 carbon atoms.

Patent Document 8 proposes a polyurethane for synthetic leather having excellent balance of physical properties including flexibility, chemical resistance, low-temperature characteristics, heat resistance and texture. There is here proposed a polyurethane for synthetic leather, obtained by reacting at least (a) a compound having two or more isocyanate groups in one molecule, (b) a chain extender and (c) a polycarbonate diol, in which the polycarbonate diol (c) is a polycarbonate diol having a hydroxyl value of 20 mg-KOH/g or more and 45 mg-KOH/g or less, having a glass transition temperature of −30° C. or less, as measured by a differential scanning calorimeter, and allowing a dihydroxy compound obtained by hydrolysis of the polycarbonate diol to have an average number of carbon atoms of 3 or more and 5.5 or less.

In recent years, an environment-responsive polyurethane has been proposed. For example, Patent Document 9 proposes a two-liquid-type non-solvent polyurethane for synthetic leather, the polyurethane including a urethane prepolymer composition used in the form of a high molecular product by a reaction of a crosslinking agent with active hydrogen in a component, in which the urethane prepolymer composition contains at least 20 to 80% by mass of a hydroxyl group-terminated urethane prepolymer having a hydroxyl value of 10 to 100 mgKOH/g and further contains 20 to 80% by mass of an oligomer having a hydroxyl value of 20 to 400 mgKOH/g and having no urethane bond, and capable of being crosslinked with the crosslinking agent while serving as a medium of the polymer, and is at least in the form of a liquid at a temperature of 30° C. with having a substantially 100% of a non-volatile content, and the polyurethane including 90 to 150% by equivalent of a polyisocyanate crosslinking agent having a NCO content of 5 to 35% by mass relative to the average hydroxyl value of the urethane prepolymer composition.

### LIST OF PRIOR ART DOCUMENTS

### Patent Document

Patent Document 1: Japanese Patent No. 3142102
Patent Document 2: Japanese Patent Laid-Open No. 2003-119314
Patent Document 3: Japanese Patent Laid-Open No. 2004-346094
Patent Document 4: Japanese Patent No. 4177318
Patent Document 5: Japanese Patent Laid-Open No. 2009-185260
Patent Document 6: Japanese Patent Laid-Open No. 2013-108196
Patent Document 7: Japanese Patent Laid-Open No. H4-342785
Patent Document 8: Japanese Patent Laid-Open No. 2016-8234
Patent Document 9: Japanese Patent Laid-Open No. 2014-105250

### SUMMARY OF INVENTION

### Problems to be Solved by Invention

However, although having hydrolysis resistance, the synthetic leather disclosed in Patent Documents 1 to 5 is not sufficient in sweat resistance in an application where high durability is required, for example, an automobile sheet.

Although capable of providing synthetic leather excellent in sweat resistance and the like, the polycarbonate diol described in Patent Document 6 requires the use of a large amount of an organic solvent when formed into a polyurethane resin solution to produce synthetic leather, and has room of further improvement in terms of environmental load.

Although a leather application is stated with respect to the invention recited in Patent Document 7, there is not found any statement in which the invention is suitable in an application where high durability is required, for example, an automobile sheet, and there is also not described any decrease in amount of a solvent used in production of synthetic leather.

The polyurethane for synthetic leather, disclosed in Patent Document 8, also requires the use of a large amount of an organic solvent when formed into a polyurethane resin solution to produce synthetic leather, and is not desirable from the viewpoint of environmental load.

The polyurethane prepolymer composition for synthetic leather, disclosed in Patent Document 9, leads to the use of an ether-based polyol having a hydroxyl value of 20 to 400 mgKOH/g, such as poly-THF or THF-neopentyl glycol copolymerized polyol, as an oligomer having no urethane bond in order to achieve non-solvent composition, and thus has reduced heat resistance and has the problem of limited applications.

An object of the present invention in view of the above problems is to provide an environment-responsive polyester polycarbonate polyol which can be used to produce a polyurethane having excellent balance of physical properties of flexibility (texture), chemical resistance, low-temperature characteristics, heat resistance, hydrolysis resistance, wear resistance, adhesiveness and appearance, and also in which the amount of a solvent used in production of synthetic leather from such a polyurethane produced is small.

### Means for Solving Problems

The present inventors have made intensive studies, and as a result, have found that a specific polyester polycarbonate polyol in the form of a liquid at ordinary temperature can be used to thereby produce a polyurethane having excellent balance of physical properties of flexibility (texture), chemical resistance, hydrolysis resistance, low-temperature characteristics, heat resistance, wear resistance, adhesiveness and appearance, and also decrease the amount of a solvent used in production of synthetic leather from such a polyurethane produced, leading to completion of the present invention.

In other words, the present invention includes the following aspects.

[1]

A polyester polycarbonate polyol comprising a repeating unit represented by the following formula (1) and a repeating unit represented by the following formula (2), having a hydroxyl value of 35 to 85 mgKOH/g, having a hydroxyl group at a terminal, and being in the form of a liquid at ordinary temperature:

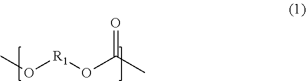

wherein R1 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, comprises at least one branch-containing alkylene group having 4 to 15 carbon atoms, and comprises at least one linear alkylene group having 2 to 10 carbon atoms;

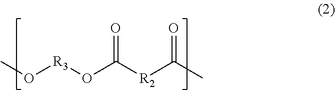

wherein R2 represents an alkylene group having 2 to 15 carbon atoms, and R3 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, comprises at least one branch-containing alkylene group having 4 to 15 carbon atoms, and comprises at least one linear alkylene group having 2 to 10 carbon atoms.
[2]

The polyester polycarbonate polyol according to [1], wherein a molar ratio (formula (1)/formula (2)) between a content rate of the repeating unit represented by the formula (1) and a content rate of the repeating unit represented by the formula (2) is 30/70 to 90/10.

[3]

The polyester polycarbonate polyol according to [1] or [2], wherein R1 in the formula (1) and/or R3 in the formula (2) comprise(s) at least one selected from the group consisting of a branch-containing alkylene group having 4 to 15 carbon atoms and at least two selected from the group consisting of a linear alkylene group having 2 to 10 carbon atoms.

[4]

The polyester polycarbonate polyol according to any of [1] to [3], wherein a viscosity measured at 50° C. with a rotatory viscometer is 1000 to 10000 mPa·s.

[5]

The polyester polycarbonate polyol according to any of [1] to [4], wherein the repeating unit represented by the formula (1) comprises 50% by mol or more of at least two repeating units selected from the group consisting of a repeating unit represented by the following formula (3), a repeating unit represented by the following formula (4), a repeating unit represented by the following formula (5), a repeating unit represented by the following formula (6) and a repeating unit represented by the following formula (7).

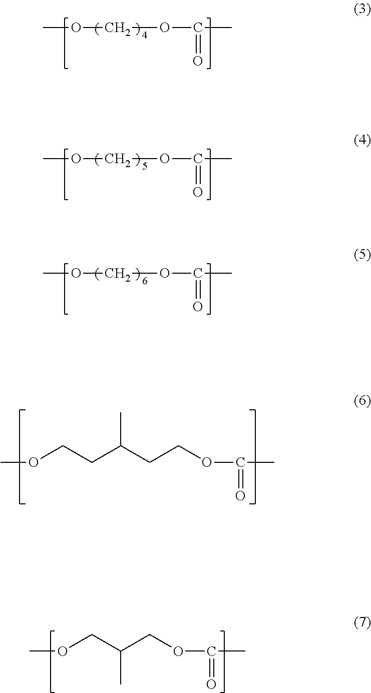

The polyester polycarbonate polyol according to any of [1] to [5], wherein a raw material used in the polyol is a bio-derived raw material.

[7]

A curable composition produced by using the polyester polycarbonate polyol according to any of [1] to [6] and reacting the same with an organic diisocyanate and a chain elongating agent.

[8]

Synthetic leather produced by using the polyester polycarbonate polyol according to any of [1] to [6].

[9]

An aqueous polyurethane produced by using the polyester polycarbonate polyol according to any of [1] to [6].

### Advantages of Invention

The polyester polycarbonate polyol of the present invention can be used to thereby produce a polyurethane having excellent balance of physical properties of flexibility (texture), chemical resistance, low-temperature characteristics, heat resistance, hydrolysis resistance, wear resistance, adhesiveness and appearance and also decrease the amount of a solvent used in production of synthetic leather from such a polyurethane produced.

### BRIEF DESCRIPTION OF DRAWINGS

FIG. 1 is a cross-sectional view of one example of synthetic leather using the polyester polycarbonate polyol of the present invention.

FIG. 2 is a diagram illustrating one example of a production process chart of synthetic leather by use of the polyester polycarbonate polyol of the present invention.

### MODE FOR CARRYING OUT INVENTION

Hereinafter, a mode for carrying out the present invention (hereinafter, abbreviated as “the present embodiment”.) is described in detail. The present invention is not limited to the following embodiments, and can be variously modified and then carried out within the gist thereof.

### <Polyester Polycarbonate Polyol>

The polyester polycarbonate polyol of the present embodiment has a repeating unit represented by the following formula (1) and a repeating unit represented by the following formula (2), has a hydroxyl value of 35 to 85 mgKOH/g, has a hydroxyl group at a terminal, and is in the form of a liquid at ordinary temperature:

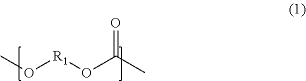

wherein R1 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, includes at least one branch-containing alkylene group having 4 to 15 carbon atoms, and includes at least one linear alkylene group having 2 to 10 carbon atoms;

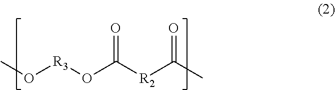

wherein R2 represents an alkylene group having 2 to 15 carbon atoms, and R3 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, includes at least one branch-containing alkylene group having 4 to 15 carbon atoms, and includes at least one linear alkylene group having 2 to 10 carbon atoms.

The polyester polycarbonate polyol of the present embodiment can be usually cured by using a curing agent such as polyisocyanate, and can be used in, for example, a polyurethane for various molded products, adhesives, coating agents, or the like.

The ordinary temperature in the present embodiment is a temperature in the range of 5° C. or more and 35° C. or less. The in the form of a liquid in the present embodiment means a state in which even a slight fluidity is exhibited.

The polyester polycarbonate polyol of the present embodiment has a hydroxyl value of 35 to 85 mgKOH/g, preferably 40 to 75 mgKOH/g, further preferably 50 to 65 mgKOH/g.

With the hydroxyl value of the polyester polycarbonate polyol of the present embodiment of 35 mgKOH/g or more, a polyurethane obtained tends to be excellent in strength and chemical resistance. With the hydroxyl value of the polyester polycarbonate polyol of the present embodiment of 85 mgKOH/g or less, synthetic leather obtained tends to be enhanced in flexibility (texture) and low-temperature characteristics.

The viscosity of the polyester polycarbonate polyol of the present embodiment, as measured at 50° C. with a rotatory viscometer, (hereinafter, also designated as “melt viscosity at 50° C.”) is preferably 1000 to 10000 mPa·s, more preferably 1200 to 9500 mPa·s, further preferably 1300 to 9000 mPa·s. With the melt viscosity at 50° C. of the polyester polycarbonate polyol of the present embodiment of 1000 mPa·s or more, a polyurethane obtained tends to be enhanced in flexibility and low-temperature characteristics. With the melt viscosity at 50° C. of the polyester polycarbonate polyol of the present embodiment of 10000 mPa·s or less, not only a polyurethane excellent in strength and chemical resistance tends to be obtained, the amount of a solvent used can be decreased in the case of the solvent in polyurethane production.

The method for obtaining the polyester polycarbonate polyol having a melt viscosity at 50° C. in the above range is not particularly limited, and examples thereof include a method for adjusting the average molecular weight of the polyester polycarbonate polyol. Specifically, for example, a lower average molecular weight of the polyester polycarbonate polyol tends to lead to a lower melt viscosity at 50° C., and a higher average molecular weight of the polyester polycarbonate polyol tends to lead to a higher melt viscosity at 50° C. The average molecular weight of the polyester polycarbonate polyol can be controlled by, for example, the molecular weight of each raw material, and the reaction time.

The average number of hydroxyl groups in one molecule of the polyester polycarbonate polyol of the present embodiment is preferably 1.7 to 3.5, more preferably 1.8 to 3.0, further preferably 2.0 to 2.5. With the average number of hydroxyl groups in one molecule of the polyester polycarbonate polyol of the present embodiment of 1.7 or more, a polyurethane obtained tends to be enhanced in strength, chemical resistance, heat resistance and hydrolysis resistance. With the average number of hydroxyl groups in one molecule of the polyester polycarbonate polyol of the present embodiment of 3.5 or less, not only a proper curing time is achieved in polyurethane production, but also a polyurethane obtained tends to be favorable in flexibility.

The carbonate group content in one molecule of the polyester polycarbonate polyol of the present embodiment is preferably 15 to 40% by mass, more preferably 21 to 38% by mass, further preferably 25 to 35% by mass. With the carbonate group content of the polyester polycarbonate polyol of the present embodiment of 15% by mass or more, a polyurethane obtained tends to be excellent in strength, chemical resistance, wear resistance and hydrolysis resistance. With the carbonate group content of the polyester polycarbonate polyol of the present embodiment of 40% by mass or less, not only a polyurethane obtained tends to be excellent in low-temperature characteristics and flexibility, but also the viscosity of a polyurethane obtained is kept low and thus the appearance of a polyurethane product tends to be excellent.

In the present embodiment, the carbonate group content is an amount of a carbonate group contained in one molecule of the polyester polycarbonate polyol, and is specifically determined by the following expression (i).

Carbonate group content (% by mass)=(Molecular weight of carbonate group)×(Number of carbonate groups in one molecule)/(Number average molecular weight of polyester polycarbonate polyol)×100 (i)
wherein the molecular weight of a carbonate group (—O—C═O—O—) is 60.01.

The polyester polycarbonate polyol of the present embodiment has a repeating unit represented by the following formula (1) and a repeating unit represented by the following formula (2), and has a hydroxyl group at a molecular terminal:

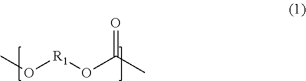

wherein R1 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, includes at least one branch-containing alkylene group having 4 to 15 carbon atoms, and includes at least one linear alkylene group having 2 to 10 carbon atoms (preferably 2 to 5 carbon atoms);

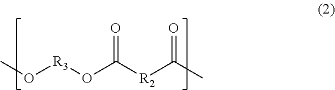

wherein R2 represents an alkylene group having 2 to 15 carbon atoms, and R3 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, includes at least one branch-containing alkylene group having 4 to 15 carbon atoms, and includes at least one linear alkylene group having 2 to 10 carbon atoms (preferably 2 to 5 carbon atoms).

R1 in the formula (1) and/or R3 in the formula (2) preferably include(s) at least one selected from the group consisting of a branch-containing alkylene group having 4 to 15 carbon atoms and at least two selected from the group consisting of a linear alkylene group having 2 to 10 carbon atoms. With such an alkylene group included, synthetic leather formed tends to be particularly excellent in washing resistance and hydrolysis resistance. With the number of carbon atoms of the linear alkylene group having 2 to 10 carbon atoms in R1 and/or R3 being smaller, a polyurethane obtained tends to be more favorable in chemical resistance. From this viewpoint, the linear alkylene group having 2 to 10 carbon atoms in R1 and/or R3 is preferably a linear alkylene group having 2 to 8 carbon atoms, more preferably a linear alkylene group having 2 to 6 carbon atoms, particularly preferably a linear alkylene group having 2 to 5 carbon atoms.

The molar ratio (formula (1)/formula (2)) between the content rate of the repeating unit represented by the formula (1) (hereinafter, also designated as “polycarbonate structural unit”) and the content rate of the repeating unit represented by the formula (2) (hereinafter, also designated as “polyester structural unit”) in the polyester polycarbonate polyol of the present embodiment is preferably 5/95 to 95/5, more preferably 30/70 to 90/10, further preferably 50/50 to 80/20. With the molar ratio between the content rate of the polycarbonate structural unit and the content rate of the polyester structural unit in the polyester polycarbonate polyol of the present embodiment being in the above range, a polyurethane excellent in flexibility, chemical resistance, adhesiveness and hydrolysis resistance tends to be obtained.

The polyester polycarbonate polyol of the present embodiment is not particularly limited in terms of the production method thereof and can be, for example, synthesized by using a bifunctional diol compound, if necessary, a tri- or higher functional polyhydric alcohol, a dibasic acid and a carbonic acid ester, as raw materials, according to a transesterification reaction described in, for example, “Polymer Reviews vol. 9, pages 9 to 20”.

Examples of the bifunctional diol compound for use in the transesterification reaction include a diol compound having a divalent linear aliphatic or alicyclic hydrocarbon backbone having 2 to 15 carbon atoms, and a diol compound having a branch-containing alkylene group (hereinafter, also designated as “branched alkylene group”) having 4 to 15 carbon atoms. The bifunctional diol compound is used in combination of two or more kinds thereof, and at least one of such two or more bifunctional diol compounds is a diol compound having a branch-containing alkylene group having 4 to 15 carbon atoms and at least one of such two or more bifunctional diol compounds is a diol compound having a linear alkylene group having 2 to 10 carbon atoms (preferably 2 to 5 carbon atoms).

The diol compound having a divalent linear aliphatic or alicyclic hydrocarbon backbone having 2 to 15 carbon atoms is not particularly limited, and specific examples thereof include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,3-cyclohexanediol, 1,4-cyclohexanediol, and 1,4-cyclohexanedimethanol.

The diol compound having a branch-containing alkylene group having 4 to 15 carbon atoms is not particularly limited, and specific examples thereof include 2-methyl-1,3-propanediol, 2,2-dimethyl-1,3-propanediol, 3-methyl-1,5-pentanediol, 2-methyl-1,8-octanediol, 2-ethyl-1,6-hexanediol, 2,4-dimethyl-1,5-pentanediol, and 2,4-diethyl-1,5-pentanediol.

In particular, a diol compound having a linear alkylene group having 3 to 12 carbon atoms and a diol compound having a branched alkylene group having 4 to 9 carbon atoms are preferable, and a diol compound having a linear alkylene group having 4 to 6 carbon atoms and a diol compound having a branched alkylene group having 4 to 6 carbon atoms are more preferable, from the viewpoint that a polyurethane excellent in flexibility (touch), chemical resistance, low-temperature characteristics and heat resistance is obtained. A plant-derived raw material, namely, a bio-derived raw material is not particularly limited, and ethylene glycol, 1,3-propanediol, 1,4-butanediol, 1,5-pentanediol, 1,6-hexanediol, 1,10-decanediol, or the like may be used.

The diol compound having a branched alkylene group, among such bifunctional diol compounds, has 2 or more carbon atoms and thus not only the viscosity of a polyurethane can kept low and the amount of an organic solvent used in production of synthetic leather from such a polyurethane can be decreased, but also a cured product obtained tends to be enhanced in flexibility and low-temperature characteristics. The diol compound having a branched alkylene group has 15 or less carbon atoms and thus a polyurethane obtained tends to be excellent in chemical resistance. The diol compound having a branched alkylene group having 4 to 6 carbon atoms, among such diol compounds each having a branched alkylene group, is particularly preferable because a polyurethane obtained tends to be excellent in hydrolysis resistance.

The bifunctional diol compound has 2 or more carbon atoms and thus not only the viscosity of a polyurethane can be kept low and the amount of an organic solvent used in production of synthetic leather from such a polyurethane can be decreased, but also a cured product obtained tends to be enhanced in flexibility and low-temperature characteristics. The bifunctional diol compound has 15 or less carbon atoms and thus a polyurethane obtained tends to be excellent in chemical resistance. In particular, with the use of the diol compound having a linear alkylene group having 2 to 10 carbon atoms (preferably 2 to 5 carbon atoms), among such bifunctional diol compounds, a polyurethane obtained tends to be excellent in chemical resistance and cohesiveness.

With the use of two or more of such bifunctional diol compounds and at least one thereof being a diol compound having a branch-containing alkylene group having 4 to 15 carbon atoms, a polyester polycarbonate polyol obtained has reduced regularity of a structural unit and reduced crystallinity, resulting in a tendency to not only obtain a liquid polyester polycarbonate polyol at ordinary temperature, but also enhance flexibility of a polyurethane. In a case where an organic solvent is used in polyurethane production, the amount of the organic solvent used tends to be able to be decreased. In particular, with the use of at least one selected from the group consisting of a diol compound having a branch-containing alkylene group having 4 to 15 carbon atoms and at least two selected from the group consisting of a diol compound having a linear alkylene group having 2 to 10 carbon atoms in combination, synthetic leather formed from a polyester polycarbonate polyol obtained tends to be particularly excellent in washing resistance and hydrolysis resistance. With the number of carbon atoms of the diol compound as a raw material of the polyester polycarbonate polyol being smaller, a polyurethane formed from a polyester polycarbonate polyol obtained tends to be more excellent in chemical resistance. The diol compound of the raw material is preferably a diol compound having a linear alkylene group having 2 to 8 carbon atoms, more preferably a diol compound having a linear alkylene group having 2 to 6 carbon atoms, particularly preferably a diol compound having a linear alkylene group having 2 to 5 carbon atoms, from the above viewpoints.

In the present embodiment, not only such a bifunctional diol, but also, if necessary, a tri- or higher functional polyhydric alcohol compound can be used as each raw material of the polyester polycarbonate polyol.

In the present embodiment, the repeating unit represented by the formula (1) preferably includes 50% by mol or more, more preferably 70% by mol or more, further preferably 80% by mol or more of at least two repeating units selected from the group consisting of a repeating unit represented by the following formula (3), a repeating unit represented by the following formula (4), a repeating unit represented by the following formula (5), a repeating unit represented by the following formula (6) and a repeating unit represented by the following formula (7).

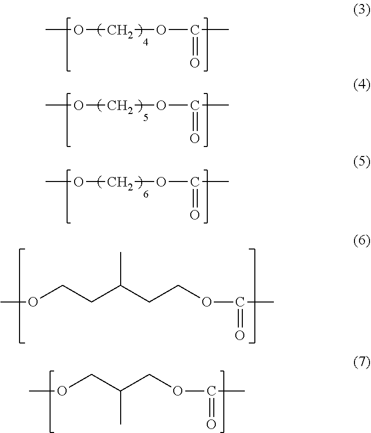

With the content of at least two repeating units selected from the group consisting of the repeating unit represented by the formula (3), the repeating unit represented by the formula (4), the repeating unit represented by the formula (5), the repeating unit represented by the formula (6) and the repeating unit represented by the formula (7) in the repeating unit represented by the formula (1) being 50% by mol or more, not only a polyurethane obtained is excellent in flexibility (touch), chemical resistance, low-temperature characteristics and heat resistance, but also the amount of a solvent used tends to be able to be decreased in the case of using the solvent in polyurethane production.

The upper limit of the content of at least two repeating units selected from the group consisting of the repeating unit represented by the formula (3), the repeating unit represented by the formula (4), the repeating unit represented by the formula (5), the repeating unit represented by the formula (6) and the repeating unit represented by the formula (7) in the repeating unit represented by the formula (1) is not particularly limited, and is, for example, 90% by mol or less.

In the present embodiment, in a case where two repeating units are selected from the repeating units represented by the formula (3), the formula (4), the formula (5), the formula (6) and the formula (7), the ratio of copolymerization of the two repeating units on a molar ratio is preferably 90:10 to 10:90, more preferably 70:30 to 30:70, further preferably 60:40 to 40:60. With the ratio of copolymerization being in the above range, the crystallinity of the polyester polycarbonate polyol tends to be reduced to thereby obtain a polyurethane having high flexibility, favorable low-temperature characteristics and touch. Furthermore, when the ratio of copolymerization is in this range, the amount of a solvent used tends to be able to be decreased in the case of the solvent in polyurethane production.

In the present embodiment, in a case where three repeating units are selected from the repeating units represented by the formula (3), the formula (4), the formula (5), the formula (6) and the formula (7), the proportion of each of the structural units is preferably 5% by mol or more, more preferably 10% by mol or more, further preferably 20% by mol or more under the assumption that the total of such three repeating units of the repeating units represented by the formula (3), the formula (4), the formula (5), the formula (6) and the formula (7) is 100% by mol. The proportion of each of the repeating units represented by the formula (3), the formula (4), the formula (5), the formula (6) and the formula (7) in the total of such three repeating units thereof is in the above range and thus a polycarbonate polyol has reduced crystallinity, resulting in a tendency to obtain a polyurethane having high flexibility, favorable low-temperature characteristics and touch. Furthermore, with the proportion of each of such three repeating units of the repeating units represented by the formula (3), the formula (4), the formula (5), the formula (6) and the formula (7) being in the above range, the amount of a solvent used tends to be able to be decreased in the case of using the solvent in polyurethane production.

The tri- or higher functional polyhydric alcohol compound is not particularly limited, and examples thereof include trimethylolethane, trimethylolpropane, hexanetriol, pentaerythritol and glycerin. With the use of the tri- or higher functional polyhydric alcohol, the average number of hydroxyl groups in one molecule can be easily adjusted in the range of 1.7 to 3.5.

The dibasic acid which can be used for synthesis of the polyester polycarbonate polyol of the present embodiment is not particularly limited, and examples thereof include aliphatic and/or aromatic dicarboxylic acid(s). The aliphatic dicarboxylic acid is not particularly limited, and examples thereof include oxalic acid, malonic acid, succinic acid, glutaric acid, adipic acid, pimelic acid, suberic acid, azelaic acid and sebacic acid. Examples of the aromatic dicarboxylic acid include phthalic acid, isophthalic acid and terephthalic acid.

The aliphatic dicarboxylic acid is particularly preferable in order to obtain a cured product excellent in flexibility, and in particular, succinic acid, glutaric acid or adipic acid is preferable. Such a dicarboxylic acid can also be used in the form of an ester with an alcohol, and can be used in the form of a methyl ester such as dimethyl succinate, dimethyl glutarate, or dimethyl adipate. Such a dicarboxylic acid may be used singly or as a mixture of a plurality of kinds thereof. A plant-derived raw material, namely, a bio-derived raw material is not particularly limited, and succinic acid, sebacic acid, or the like may be used.

The carbonic acid ester which can be used for synthesis of the polyester polycarbonate polyol of the present embodiment is not particularly limited, and examples thereof include dialkyl carbonates such as dimethyl carbonate, diethyl carbonate, dipropyl carbonate and dibutyl carbonate; diaryl carbonates such as diphenyl carbonate; and alkylene carbonates such as ethylene carbonate, trimethylene carbonate, 1,2-propylene carbonate, 1,2-butylene carbonate, 1,3-butylene carbonate and 1,2-pentylene carbonate. The carbonic acid ester here used is preferably dimethyl carbonate, diethyl carbonate, diphenyl carbonate or ethylene carbonate from the viewpoints of availability and ease of condition setting of a polymerization reaction.

A catalyst may or may not be added in production of the polyester polycarbonate polyol of the present embodiment. In a case where a catalyst is added, the catalyst can be freely selected from catalysts for use in a usual transesterification reaction. The catalyst here used is not particularly limited, and is, for example, any of metals such as lithium, sodium, potassium, rubidium, cesium, magnesium, calcium, strontium, barium, zinc, aluminum, titanium, zirconium, hafnium, cobalt, germanium, tin, lead, antimony, arsenic and cerium, and metal salts thereof, metal alkoxides thereof and organic compounds including such metals. Among these catalysts, a metal alkoxide is preferable, and an alkoxide of titanium, zirconium or hafnium in Group 4 in the periodic table is particularly preferable because of being hardly affected by water generated and being capable of maintaining high activity.

The amount of the catalyst used is usually 0.00001 to 0.1% by mass, preferably 0.001 to 0.05% by mass, further preferably 0.01 to 0.03% by mass based on the mass of the bifunctional diol compound as a raw material and the tri- or higher functional polyhydric alcohol, if necessary, optionally included. With the amount of the catalyst of 0.0001% by mass or more, the reaction speed can be reduced and productivity is improved. With the amount of the catalyst of 0.1% by mass or less, the color tone of the polyester polycarbonate polyol is excellent.

The method for producing the polyester polycarbonate polyol in the present embodiment can include synthesis by a transesterification reaction using the bifunctional diol compound, if necessary, the tri- or higher functional polyhydric alcohol, the dibasic acid, and the carbonic acid ester, as raw materials, as described above.

More specifically, the transesterification reaction is performed according to the following procedure.

First, two or more bifunctional diol compounds at a predetermined ratio are used in combination, a diol compound having a branch-containing alkylene group having 4 to 15 carbon atoms is used as at least one of such two or more bifunctional diol compounds, a diol compound having a linear alkylene group having 2 to 10 carbon atoms is used as at least one of such two or more bifunctional diol compounds, one or more optional tri- or higher functional polyhydric alcohols at a predetermined ratio, dibasic acid at a predetermined ratio and one or more carbonic acid esters at a predetermined ratio are admixed, and these are subjected to a transesterification reaction under ordinary pressure or reduced pressure in the presence or absence of a transesterification catalyst at a temperature of preferably 100 to 200° C., more preferably 140 to 180° C.

Subsequently, any alcohol derived from the carbonic acid ester and water (in a case where a dibasic acid ester is used, a monoalcohol derived from the dibasic acid ester) derived from the dibasic acid, which are generated during the reaction, are distilled off to thereby obtain a polyester polycarbonate polyol having a molecular weight of about 300 to 500 g/mol, for example.

Next, unreacted carbonic acid esters and bifunctional diols, tri- or higher functional polyhydric alcohols optionally included, and water (in a case where a dibasic acid ester is used, a monoalcohol derived from the dibasic acid ester) generated in a condensation reaction of the dibasic acid are distilled under reduced pressure at preferably 130 to 230° C., more preferably 150 to 200° C., and the polyester polycarbonate polyol having a desired hydroxyl value can be obtained by the condensation reaction. Specifically, for example, a shorter reaction time of the condensation reaction tends to lead to a larger hydroxyl value of a polyester polycarbonate polyol obtained, and a longer reaction time of the condensation reaction tends to lead to a smaller hydroxyl value of the polyester polycarbonate polyol.

The average number of hydroxyl groups in the polyester polycarbonate polyol can be adjusted by controlling the initial ratio of components loaded, the amounts of raw materials distilled off in production, and the amount of a reaction product.

Examples of the method for producing the polyester polycarbonate polyol of the present embodiment can also include a method including producing a polycarbonate polyol and a polyester polyol in advance, then mixing the polycarbonate polyol and the polyester polyol, and subjecting the resulting mixture to a transesterification reaction under stirring in the presence or absence of the transesterification catalyst at a temperature of 100 to 250° C.

The method for producing the polycarbonate polyol and the polyester polyol is not particularly limited, and a known method can also be adopted. For example, the polycarbonate polyol can be obtained by reacting the above carbonate compound and diol compound in the presence of the transesterification catalyst. The polyester polyol can be obtained by reacting the above dibasic acid compound and diol compound in the presence of the transesterification catalyst.

The carbonic acid ester which can be used for synthesis of the polycarbonate polyol used in the present embodiment is not particularly limited, and examples thereof include dialkyl carbonates such as dimethyl carbonate, diethyl carbonate, dipropyl carbonate and dibutyl carbonate; diaryl carbonates such as diphenyl carbonate; and alkylene carbonates such as ethylene carbonate, trimethylene carbonate, 1,2-propylene carbonate, 1,2-butylene carbonate, 1,3-butylene carbonate and 1,2-pentylene carbonate. The carbonic acid ester here used is preferably dimethyl carbonate, diethyl carbonate, diphenyl carbonate or ethylene carbonate from the viewpoints of availability and ease of condition setting of a polymerization reaction.

The bifunctional diol compound which can be used for synthesis of the polycarbonate polyol or the polyester polyol used in the present embodiment is not particularly limited, and examples thereof include diols each having a divalent linear aliphatic or alicyclic hydrocarbon backbone having 2 to 15 carbon atoms, and diols each having a branch-containing alkylene group having 4 to 15 carbon atoms.

The diol compound having a divalent linear aliphatic or alicyclic hydrocarbon backbone having 2 to 15 carbon atoms is not particularly limited, and specific examples thereof include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,3-cyclohexanediol, 1,4-cyclohexanediol, and 1,4-cyclohexanedimethanol.

The diol compound having a branch-containing alkylene group having 4 to 15 carbon atoms is not particularly limited, and specific examples thereof include 2-methyl-1,3-propanediol, 2,2-dimethyl-1,3-propanediol, 3-methyl-1,5-pentanediol, 2-methyl-1,8-octanediol, 2-ethyl-1,6-hexanediol, 2,4-dimethyl-1,5-pentanediol, and 2,4-diethyl-1,5-pentanediol.

Other examples include a cyclic diol, and a diol having an aromatic ring.

The cyclic diol is not particularly limited, and examples thereof include 1,3-cyclohexanediol, 1,4-cyclohexanediol, 1,4-cyclohexanedimethanol, 2-bis(4-hydroxycyclohexyl)-propane, and 1,8-cyclooctanedimethanol.

The diol having an aromatic ring is not particularly limited, and examples thereof include p-xylenediol, p-tetrachloroxylenediol, 1,4-bis(hydroxyethoxy)benzene, and 2,2-bis [(4-hydroxyethoxy)phenyl]propane.

The dibasic acid which can be used for synthesis of the polyester polyol used in the present embodiment is not particularly limited, and examples thereof include aliphatic and/or aromatic dicarboxylic acid(s). The aliphatic dicarboxylic acid is not particularly limited, and examples thereof include oxalic acid, malonic acid, succinic acid, glutaric acid, adipic acid, pimelic acid, suberic acid, azelaic acid and sebacic acid. The aromatic dicarboxylic acid is not particularly limited, and examples thereof include phthalic acid, isophthalic acid and terephthalic acid. The aliphatic dicarboxylic acid is particularly preferable in order to obtain a cured product excellent in flexibility, and in particular, succinic acid, glutaric acid or adipic acid is preferable. Such a dicarboxylic acid can also be used in the form of an ester with an alcohol, and can be used in the form of a methyl ester such as dimethyl succinate, dimethyl glutarate, or dimethyl adipate. Such a dicarboxylic acid may be used singly or as a mixture of a plurality of kinds thereof.

A commercially available product of the polycarbonate polyol used in the present embodiment is not particularly limited, and examples thereof include trade names “Duranol T6001”, “Duranol T6002”, “Duranol S6002”, “Duranol T5651”, “Duranol T5652”, “Duranol T5650E”, “Duranol T5650J”, “Duranol T4671”, “Duranol T4672”, “Duranol T4691”, “Duranol T4692”, “Duranol G3452”, and “Duranol G3450J” manufactured by Asahi Kasei Corporation;
trade names “ETERNACOLL UH-50”, “ETERNACOLL UH-100”, “ETERNACOLL UH-200”, “ETERNACOLL UH-300”, “ETERNACOLL PH-50”, “ETERNACOLL PH-100”, “ETERNACOLL PH-200”, “ETERNACOLL PH-300”, “ETERNACOLL UHC50-100”, “ETERNACOLL UHC50-200”, “ETERNACOLL UC-100”, “ETERNACOLL UM-90 (1/3)”, “ETERNACOLL UM-90 (1/1)”, “ETERNACOLL UM-90 (3/1)”, “ETERNACOLL UP-50”, “ETERNACOLL UP-100”, and “ETERNACOLL UP-200” manufactured by UBE Corporation;
trade names “Kuraray Polyol C-1065N”, “Kuraray Polyol C-2065N”, “Kuraray Polyol C-1090”, “Kuraray Polyol C-2090”, “Kuraray Polyol C-3090”, “Kuraray Polyol C-1050”, “Kuraray Polyol C-2050”, “Kuraray Polyol C-3050”, “Kuraray Polyol C-1015N”, and “Kuraray Polyol C-2015N” manufactured by Kuraray Co., Ltd.;
trade names “Placcel 220EC”, “Placcel CD205”, “Placcel CD210”, “Placcel CD220”, “Placcel CD205PL”, “Placcel CD205HL”, “Placcel CD210PL”, “Placcel CD210HL”, “Placcel CD220PL”, “Placcel CD220HL”, “Placcel CD220EC”, and “Placcel CD221T” manufactured by Daicel Corporation;
trade names “Nippolan 981”, “Nippolan 980R”, “Nippolan 982R”, “Nippolan 976”, “Nippolan 965”, “Nippolan 963”, “Nippolan 964”, and “Nippolan 968” manufactured by Tosoh Corporation;
“Oxymer N112” manufactured by Perstorp Holding AB; and trade names “BENEBiOL NL1010DB”, “BENEBiOL NL2010DB”, “BENEBiOL NL3010DB”, “BENEBiOL NL1005B”, “BENEBiOL NL2005B”, “BENEBiOL NL1030B”, “BENEBiOL HS0830B”, “BENEBiOL HS0840B”, “BENEBiOL HS0840H”, and “BENEBiOL HS0850H” manufactured by Mitsubishi Chemical Corporation. These may be used singly or in any combination of two or more kinds thereof.

A commercially available product of the polyester polyol used in the present embodiment is not particularly limited, and examples thereof include trade name “Kyowapol” series, manufactured by Kyowa Hakko Chemical Co., Ltd.; trade name “Kuraray Polyol” series, manufactured by Kuraray Co., Ltd.; trade name “Placcel” series, manufactured by Daicel Corporation; trade name “Polylite” series, manufactured by DIC Corporation; trade name “Nippolan” series, manufactured by Tosoh Corporation; polyesters each obtained by a ring-opening reaction of a cyclic ester compound such as castor oil-modified polyol or ε-caprolactone, and copolymerized polyesters thereof.

The bifunctional diol compounds included in the polycarbonate polyol and the polyester polyol used in production of the polyester polycarbonate polyol of the present embodiment are each used in combination of two or more kinds thereof, and at least one of such two or more bifunctional diol compounds is a diol compound having a branch-containing alkylene group having 4 to 15 carbon atoms and at least one of such two or more bifunctional diol compounds is a diol compound having a linear alkylene group having 2 to 10 carbon atoms (preferably 2 to 5 carbon atoms).

In particular, a diol compound having a linear alkylene group having 3 to 12 carbon atoms and a diol compound having a branched alkylene group having 4 to 9 carbon atoms are preferable and a diol compound having a linear alkylene group having 4 to 6 carbon atoms and a diol compound having a branched alkylene group having 4 to 6 carbon atoms are more preferable from the viewpoint that a polyurethane excellent in flexibility (touch), chemical resistance, low-temperature characteristics and heat resistance is obtained.

The polycarbonate polyol and the polyester polyol used in production of the polyester polycarbonate polyol of the present embodiment may be each one in which a catalyst poison such as a phosphoric acid ester compound is added in order to deactivate the transesterification reaction catalyst used in the production.

In a case where a catalyst poison or the like for the transesterification reaction catalyst used in the production is included in the polycarbonate polyol or the polyester polyol as a raw material, the transesterification reaction with the polycarbonate polyol and the polyester polyol tends to usually hardly progress. Therefore, a required amount of the above transesterification reaction catalyst can be newly added in production of the polyester polycarbonate polyol of the present embodiment.

On the other hand, in a case where a catalyst poison for the transesterification reaction catalyst is not included in the polycarbonate polyol or the polyester polyol as a raw material, the transesterification reaction tends to usually easily progress in the present embodiment. However, for example, also in a case where the reaction temperature and the reaction time in a production process of the polyester polycarbonate polyol of the present embodiment are tried to be respectively more decreased and more shortened, a required amount of the transesterification reaction catalyst can be newly added. In this case, the transesterification reaction catalyst can be freely selected from the above-mentioned catalysts used in a usual transesterification reaction.

In a method for producing a polyurethane by using the polyester polycarbonate polyol of the present embodiment (hereinafter, also designated as “component (a)”), a curing agent such as a polyisocyanate (hereinafter, also designated as “component (b)”) and, if necessary, a chain extender (hereinafter, also designated as “component (c)”) are usually used.

The method for producing a polyurethane by using the polyester polycarbonate polyol of the present embodiment may be a method for providing a curable composition by compounding the component (a), the component (b), and the component (c) constituting the composition at one time, or may be a method for providing a curable composition as a mixture obtained by preparing an isocyanate-terminated prepolymer composition obtained by reacting the component (a) with the component (b) in advance, and compounding the isocyanate-terminated prepolymer composition and the component (c).

The curable composition of the present embodiment is produced by using the above polyester polycarbonate polyol and reacting the same with an organic diisocyanate and a chain elongating agent.

The polyisocyanate used in the case of production of a polyurethane by using the polyester polycarbonate polyol of the present embodiment can be usually a polyisocyanate having an average number of functional groups per molecule, of 2 to 10 (component (b)).

The polyisocyanates of the component (b) are not particularly limited, and examples thereof can include aromatic diisocyanates such as 2,4-tolylene diisocyanate, 2,6-tolylene diisocyanate and a mixture thereof, diphenylmethane-4,4′-diisocyanate (MDI), naphthalene-1,5-diisocyanate (NDI), 3,3′-dimethyl-4,4′biphenylene diisocyanate (TODI) and polymethylenepolyphenylene polyisocyanate (PMDI); aromatic aliphatic diisocyanates such as xylylene diisocyanate (XDI) and phenylene diisocyanate; and aliphatic diisocyanates such as 4,4′-methylenebiscyclohexyl diisocyanate (hydrogenation (also referred to as hydrogenated) MDI), hexamethylene diisocyanate (HDI), isophorone diisocyanate (IPDI) and cyclohexane diisocyanate (hydrogenated XDI).

The polyisocyanates of the component (b) can also be a polyisocyanate having 2.1 or more isocyanate groups on average in one molecule. The polyisocyanate having 2.1 or more isocyanate groups on average in one molecule to be used is not particularly limited, and can be, for example, any of aromatic polyisocyanates such as crude MDI and crude TDI; derivatives of aliphatic isocyanates such as HDI and IPDI, specifically diisocyanate derivatives such as biuret, allophanate, uretdione and isocyanurate; and polyhydric alcohol adducts.

The polyisocyanate having 2.1 or more isocyanate groups in one molecule is not particularly limited, and is, for example, available as any of trade names Sumijule 44S and 44V70 (both manufactured by Sumika Bayer Urethane Co., Ltd.), trade name Desmodur HL (manufactured by Sumika Bayer Urethane Co., Ltd.) as a copolymer of TDI and HDI, various Duranates manufactured by Asahi Kasei Corporation, namely, trade names Duranate 24A-100, Duranate 22A-75PX, Duranate 18H-70B, Duranate 21S-75E, Duranate THA-100, Duranate TPA-100, Duranate MFA-75X, Duranate TSA-100, Duranate TSS-100, Duranate TSE-100, Duranate D-101, Duranate D-201, Duranate P-301-75E, Duranate E-402-90T, Duranate E-405-80T, Duranate ME20-100, Duranate 17B-60PX, Duranate TPA-B80X, Duranate MF-B60X, Duranate E-402-B80T, Duranate ME20-B80S, Duranate WB40-100, Duranate WB40-80D, Duranate WT20-100 and Duranate WT30-100.

The polyisocyanate as the component (b) to be used is preferably an aromatic polyisocyanate such as MDI. Such an aromatic polyisocyanate is used to result in a tendency to obtain a cured product having excellent mechanical properties. A curable composition, in which such an aromatic polyisocyanate such as MDI is used as the component (b), can be suitably used as an adhesive of a base fabric and a skin layer of synthetic leather.

A curable composition, in which an aliphatic polyisocyanate such as hydrogenated MDI is used as the component (b), can provide synthetic leather having an excellent weather resistance and thus is suitably used as, for example, a curable composition for synthetic leather, for a skin layer.

The polyisocyanate of the component (b) to be used can also be, for example, a so-called blocked isocyanate obtained by blocking with any known blocking agent, for example, lower alcohols such as butanol and 2-ethylhexanol, methyl ethyl ketone oxime, lactams, phenols, imidazoles, and active methylene compounds.

In a case where a polyurethane is produced by using the polyester polycarbonate polyol of the present embodiment, a chain extender (component (c)) can be, if necessary, used. The chain extender is appropriately, if necessary, used because the chain extender, while is used for enhancing wear properties and strength of a polyurethane obtained, may also cause a polyurethane obtained to be deteriorated in flexibility. The chain extender is not particularly limited, and examples thereof include short-chain diols such as ethylene glycol and 1,4-butanediol; and polyhydric alcohols such as trimethylolethane, trimethylolpropane, hexanetriol, pentaerythritol and glycerin. The chain extender is not particularly limited and examples thereof include diamines such as ethylenediamine, propylenediamine, hexamethylenediamine, tolylenediamine, xylylenediamine, diphenyldiamine, diaminodiphenylmethane, diaminocyclohexylmethane, piperazine, 2-methylpiperazine, isophoronediamine and 3,3′-dichloro-4,4′-diaminodiphenylmethane (MOCA), and water.

The amount of the chain extender added based on the total of the component (a) and the component (b) is preferably 30% by mass or less, more preferably 3% by mass or more and 20% by mass or less, further preferably 5% by mass or more and 10% by mass or less. By using a polyhydric alcohol as the chain extender, the polyurethane obtained can have increased crosslinking density and enhanced strength, wear properties and chemical resistance.

The amounts of the polyester polycarbonate polyol as the component (a), the polyisocyanate as the component (b) and the chain extender as the component (c) to be used are adjusted so that the amount represented as [Isocyanate equivalent of component (b)]/[Total of hydroxyl equivalents of both component (a) and component (c)] is preferably 0.7 to 1.3, more preferably 0.8 to 1.2, further preferably 0.9 to 1.1. With the [Isocyanate equivalent of component (b)]/[Total of hydroxyl equivalents of both component (a) and component (c)] of 0.7 or more and 1.3 or less, a polyurethane obtained can be properly controlled in molecular weight and mechanical properties such as strength, elongation and wear resistance tend to be excellent.

In a case where a polyurethane is produced by using the polyester polycarbonate polyol of the present embodiment, an inert organic solvent may be, if necessary, included in order to adjust processability in urethane production. The content of the inert organic solvent relative to the polyurethane is preferably 80% by mass or less, more preferably 70% by mass or less, further preferably 60% by mass or less. Addition of the inert organic solvent is effective in order to not only decrease the viscosity of the curable composition and enhance processability, but also more enhance the appearance of a cured product obtained.

The inert organic solvent is not particularly limited as long as it is an organic solvent substantially inert to a polyisocyanate, and is preferably one having no active hydrogen. The inert organic solvent is not particularly limited, and examples thereof include hydrocarbons such as pentane, hexane, heptane, octane, decane, petroleum ether, petroleum benzine, ligroin, petroleum spirits, cyclohexane and methylcyclohexane; fluorine-based inert liquids, for example, fluorinated oils such as trichlorofluoroethane, tetrachlorodifluoroethane and perfluoroether; and perfluorocyclohexane, perfluorobutyltetrahydrofuran, perfluorodecalin, perfluoro-n-butylamine, perfluoropolyether and dimethylpolysiloxane. These may be used singly or as a mixture thereof. Examples of the inert organic solvent further include any single or mixed solvent of methyl ethyl ketone (also designated as MEK), acetone, ethyl acetate, butyl acetate, toluene and xylene.

Any polyol other than the polyester polycarbonate polyol may be, if necessary, used in the curable composition of the present embodiment. Such any polyol other than the polyester polycarbonate polyol is not particularly limited, and examples thereof include polyether-based polyol, polyester-based polyol, polycarbonate-based polyol, polyolefin-based polyol, polybutadiene-based polyol, polyacrylic polyol, and oil-modified polyol.

The amount of such any polyol other than the polyester polycarbonate polyol, added, based on the total mass of the polyester polycarbonate polyol and such any polyol other than the polyester polycarbonate polyol is preferably 50% by mass or less, more preferably 30% by mass or less, further preferably 20% by mass or less.

### <Other Additive(s)>

In a case where a polyurethane is produced by using the polyester polycarbonate polyol of the present embodiment, any additive(s) such as a curing accelerator (catalyst), a filler, a flame retardant, a dye, an organic or inorganic pigment, a release agent, a fluidity modifier, a plasticizer, an antioxidant, an ultraviolet absorber, a light stabilizer, a defoamer, a leveling agent, a colorant and/or a foaming agent can be added depending on the intended use.

The curing accelerator is not particularly limited, and examples thereof include amines and a metal catalyst.

The curing accelerator being any of amines is not particularly limited, and examples thereof include monoamines such as triethylamine and N,N-dimethylcyclohexylamine, diamines such as tetramethylethylenediamine, and triamines, cyclic amines, alcohol amines such as dimethylethanolamine, and ether amines.

The metal catalyst is not particularly limited, and examples thereof include potassium acetate, potassium 2-ethylhexanoate, calcium acetate, lead octylate, dibutyltin dilaurate, tin octylate, bismuth neodecanoate, bismuth oxycarbonate, bismuth 2-ethylhexanoate, zinc octylate, zincneodecanoate, phosphine and phosphorine.

The filler and the pigment are not particularly limited, and examples thereof include a woven fabric, a glass fiber, a carbon fiber, a polyamide fiber, mica, kaolin, bentonite, a metal powder, an azo pigment, carbon black, clay, silica, talc, gypsum, alumina white, barium carbonate, and calcium carbonate.

The release agent, the fluidity modifier and the leveling agent are not particularly limited, and examples thereof include silicone, aerosil, wax, stearate and polysiloxane such as BYK-331 (manufactured by BYK-Chemie).

An oxidation inhibitor, a light stabilizer, and a heat stabilizer are preferably used as the additive(s) in a case where a polyurethane is produced by using the polyester polycarbonate polyol of the present embodiment.

The oxidation inhibitor here used is not particularly limited, and can be, for example, any of phosphorus compounds such as aliphatic, aromatic or alkyl-substituted aromatic esters of phosphoric acid or phosphorus acid, hypophosphorous acid derivatives, phenylphosphonic acid, phenylphosphinic acid, diphenylphosphonic acid, polyphosphonate, dialkyl pentaerythritol diphosphite and dialkylbisphenol A diphosphite; phenol-based derivatives, in particular, hindered phenol compounds, and sulfur-containing compounds such as thioether-based, dithionic acid salt-based, mercaptobenzimidazole-based, and thiocarbanilide-based compounds and thiodipropionic acid esters; and tin-based compounds such as tin malate and dibutyltin monooxide. These may be used singly or in combinations of two or more kinds thereof.

### <Method for Producing Synthetic Leather>

Synthetic leather can be produced by applying the method for producing a polyurethane by using the polyester polycarbonate polyol of the present embodiment. The method for producing synthetic leather by using the polyester polycarbonate polyol of the present embodiment is not particularly limited, and examples thereof include a wet method involving wet coagulation by coating or impregnating a base material (base fabric) with the polyurethane produced by using the polyester polycarbonate polyol of the present embodiment, and a dry method involving coating release paper or a base material (base fabric) with a polyurethane produced by using the polyester polycarbonate polyol of the present embodiment and drying the resultant.

The method for producing synthetic leather to be employed can also be a transfer coating method (one dry method) involving coating release paper with a polyurethane produced by using the polyester polycarbonate polyol of the present embodiment to form a skin material, then laminating thereon a base material (base fabric) with the polyurethane produced by using the polyester polycarbonate polyol of the present embodiment, used as an adhesion layer, and thereafter removing the release paper.

The method for producing synthetic leather is described below with a dry method as an example.

The base material (base fabric) here used can be any of various base materials, and is not particularly limited, and examples thereof include a fibrous base material. The fibrous base material is not particularly limited, and examples thereof include a fiber aggregate obtained by forming a fiber into a non-woven fabric, a woven fabric, a net cloth or the like, or a fiber aggregate in which each fiber is bound by an elastic polymer. The fiber for use in the fiber aggregate is not particularly limited, and examples thereof include natural fibers such as cotton, linen and wool, recycled or semi-synthetic fibers such as rayon and acetate, and synthetic fibers such as polyamide, polyester, polyacrylonitrile, polyvinyl alcohol and polyolefin. Such a fiber may be a single spun fiber or a mixed spun fiber. Other base material is not particularly limited, and examples thereof include paper, release paper, a plastic film such as polyester or polyolefin, a plate of a metal such as aluminum, and a glass plate.

The curable composition for synthetic leather of the present embodiment can be subjected to coating by a method generally used. A coating tool is not particularly limited, and examples thereof can include a floating knife coater, a knife-over-roll coater, a reverse roll coater, a roll doctor coater, a gravure roll coater and a kiss roll coater.

Synthetic leather obtained can be used as it is. Alternatively, this synthetic leather can be obtained in a mode where the synthetic leather is coated with a polymer solution or emulsion of a polyurethane resin, vinyl chloride, a cellulose resin or the like, in order that various properties are further imparted. Synthetic leather can also be obtained in a mode of a laminate obtained by laminating a coating film obtained by drying of the polymer solution or emulsion applied separately on release paper and then peeling the release paper.

Hereinafter, the present embodiment is described with reference to the drawings. The drawings and production conditions described below correspond to one mode of the present embodiment, and the present embodiment is not limited thereto.

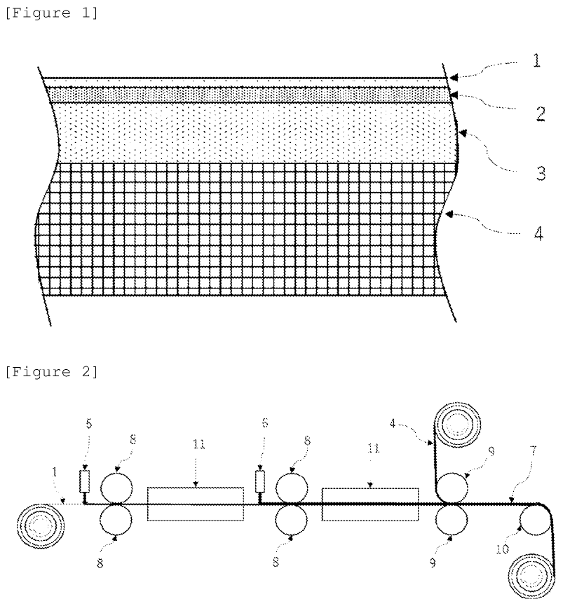

FIG. 1 is a schematic cross-sectional view of a synthetic leather laminate produced by a dry method illustrated in FIG. 2. The structure of the laminate has a skin layer 2 on a base material (non-woven fabric) 4 with an adhesion layer 3 being interposed therebetween. Release paper 1 used in production, although is attached onto the outermost layer, is peeled in use.

FIG. 2 is a schematic diagram illustrating one method for producing a dry synthetic leather laminate sheet by use of a polyurethane produced by using the polyester polycarbonate polyol of the present embodiment. In the production method, first, a curable composition obtained by mixing each raw material of the curable composition of the present embodiment, adjusted at a predetermined temperature in advance, by a mixing head 5 is allowed to flow down onto the release paper 1 (to which a leather-like pattern is usually applied).

In a case where the one-shot method is applied, the component (a), the component (b) and, if necessary, the component (c), and, if necessary, the inert organic solvent and the additive(s) are separately continuously fed to, or two including the component (b) and raw materials (mixture obtained by mixing the component (a), the component (c), if necessary, the inert organic solvent, and the additive(s)) other than such a component are continuously fed to the mixing head 5 for mixing, and the resulting mixture is allowed to flow down onto the release paper 1.

In a case where the prepolymer method is applied, two, the prepolymer composition, and a mixture of the polycarbonate polyol (component (a)) not prepolymerized and/or the chain extender (component (c)), if necessary, the inert organic solvent and the additive(s) are continuously fed to the mixing head 5 for mixing, and the mixture is allowed to flow down onto the release paper 1.

The temperature of each of the components before mixing is usually adjusted to 20 to 80° C., preferably 30 to 70° C., more preferably 40 to 60° C. The temperature of the mixing head 5 is also usually adjusted to 20° C. to 80° C., preferably 30 to 70° C., more preferably 40 to 60° C. The temperature of each of the components before mixing and the temperature of the mixing head 5 are each 20° C. or more and thus raw materials used, in particular, the polycarbonate polyols tend to be decreased in viscosity and the flow rate tends to be stabilized. The temperature of each of the components before mixing and the temperature of the mixing head 5 are each 80° C. or less and thus the curing rate of the curable composition of the present embodiment tends to be properly controlled, the curable composition tends to be inhibited from being rapidly increased in viscosity, and synthetic leather having a uniform thickness tends to be obtained.

Thereafter, a sheet having a certain thickness is formed through a coating roll 8 and then allowed to pass through a drier 11 to perform curing, and drying of the inert organic solvent, thereby forming the skin layer 2 of the synthetic leather. The temperature of the drier is usually set to 60 to 150° C., preferably 70 to 130° C., more preferably 80 to 110° C. The drying time is usually, 2 minutes to 15 minutes, preferably 3 minutes to 10 minutes, more preferably 4 minutes to 7 minutes.

Next, a curable composition of the present embodiment is obtained by mixing each raw material of a curable composition of the present embodiment adjusted at a predetermined temperature in advance, by a mixing head 6, and is allowed to flow down to thereby form the adhesion layer 3.

In a case where the one-shot method is applied in production of the adhesion layer, the component (a), the component (b) and the component (c), and, if necessary, the inert organic solvent, and the additive(s) are separately continuously fed to, or two including the component (b) and raw materials (mixture obtained by mixing the component (a), the component (c), if necessary, the inert organic solvent, and the additive(s)) other than such a component are continuously fed to the mixing head 6 for mixing, and the resulting mixture is allowed to flow down onto the skin layer.

In a case where the prepolymer method is applied in production of the adhesion layer, the prepolymer composition, the polyester polycarbonate polyol (component (a)) not prepolymerized, and, if necessary, the inert organic solvent and the additive(s) are separately continuously fed to, or two including the prepolymer composition and a mixture of raw materials (polyester polycarbonate polyol (component (a)) not prepolymerized and/or the chain extender (component (c)), if necessary, the inert organic solvent and the additive(s)) other than such a component are continuously fed to the mixing head 6 for mixing, and the resulting mixture is allowed to flow down onto the skin layer.

The temperature of each of the components before mixing is usually adjusted to 20 to 60° C., preferably 30 to 50° C., more preferably 35 to 45° C. The temperature of the mixing head 6 is also usually adjusted to 20 to 60° C., preferably 30 to 50° C., more preferably 35 to 45° C. The temperature of each of the components before mixing and the temperature of the mixing head 6 are each 20° C. or more and thus raw materials used, in particular, the polyester polycarbonate polyols tend to be decreased in viscosity and the flow rate tends to be stabilized. The temperature of each of the components before mixing and the temperature of the mixing head 6 are each 60° C. or less and thus the curing rate of the curable composition of the present embodiment tends to be properly controlled, the curable composition tends to be inhibited from being rapidly increased in viscosity, and synthetic leather having a uniform thickness tends to be obtained.

Thereafter, a sheet having a certain thickness is formed through the coating roll 8 and then allowed to pass through the drier 11 to perform curing, and drying of the inert organic solvent, thereby forming the adhesion layer 3 of the synthetic leather. Next, a base material 4 and the adhesion layer 3 are stacked and pressure bonded by a pressure bonding roll 9, and thereafter a sheet structure 7 is obtained and wound by a winding roll 10, to thereby obtain a desired synthetic leather laminate. The temperature of the drier 11 is usually set to 50 to 110° C., preferably 60 to 100° C., more preferably 70 to 90° C. The drying time is usually, 2 minutes to 15 minutes, preferably 3 minutes to 10 minutes, more preferably 4 minutes to 7 minutes.

While FIG. 2 illustrates a production example of synthetic leather including three layers of skin layer/adhesion layer/base material, a synthetic leather laminate including two layers of skin layer/base material, from which the adhesion layer is omitted, can also be produced by the same facilities. The adhesiveness of the skin layer and the base material is controlled by adjusting the curing state of the curable composition. Specifically, the synthetic leather laminate can be obtained by pressure bonding the curable composition of the present embodiment, which is in the state of being not completely cured, with the base material. Thus, the curing temperature of the drier 11 is set to 50 to 110° C., preferably 60 to 100° C., more preferably 70 to 90° C. The drying time is usually set to 2 minutes to 15 minutes, preferably 3 minutes to 10 minutes, more preferably 4 minutes to 7 minutes.

### <Application>

Synthetic leather obtained by using a polyurethane produced by using the polyester polycarbonate polyol of the present embodiment can be used in, for example, an interior material for automobiles, such as a seat for automobiles, furniture such as sofa, a clothing material, shoes, a bag, and other chandlery products. The synthetic leather is also used in, for example, an adhesive for laminate welding of various films, or a surface protection agent for such films.

An aqueous polyurethane produced by using the polyester polycarbonate polyol of the present embodiment can be used not only in the above synthetic leather, but also as various materials such as paint and a coating agent.

### EXAMPLES

Hereinafter, the present invention is further specifically described with reference to Examples and Comparative Examples, but the present invention is not limited to these Examples as long as it does not depart from the gist thereof. In the following Examples and Comparative Examples, methods for analyzing and evaluating physical properties and the like of each of the components are as follows.

### [Analysis and Evaluation of Polyester Polycarbonate Polyol]

### <Hydroxyl Value of Polyester Polycarbonate Polyol>

The hydroxyl value was measured according to JIS K1557-1. The average molecular weight of the polyester polycarbonate polyol (g/mol) was also calculated from the hydroxyl value of the resulting polyester polycarbonate polyol. The average number of hydroxyl groups in one molecule of the polyester polycarbonate polyol can be calculated according to 13C-NMR.

### <Compositional Ratio (Ratio of Copolymerization) of Polyester Polycarbonate Polyol>

A 100-mL eggplant flask was placed with 1 g of a polyester polycarbonate polyol sample, 30 g of methanol and 8 g of a 28% sodium methoxide solution in methanol, and the resultant was reacted at 100° C. for 1 hour. After a reaction liquid was cooled to room temperature, 2 to 3 droplets of phenolphthalein as an indicator were added thereto, and the liquid was neutralized by hydrochloric acid. After cooling in a refrigerator for 1 hour, filtration was made with a filter and analysis was made with gas chromatography (GC). In GC analysis, gas chromatography GC-14B (manufactured by Shimadzu Corporation in Japan) equipped with DB-WAX (manufactured by J&W in USA) as a column was used, diethylene glycol diethyl ester was used as an internal standard, a hydrogen flame ionization detector (FID) was used as a detector, and each of the components was quantitatively analyzed. The temperature rise profile of the column included retention at 60° C. for 5 minutes and then a temperature rise to 250° C. at 10° C./min.

The compositional ratio (ratio of copolymerization) of each polyester polycarbonate polyol was determined from each alcohol component and a dibasic acid-derived methyl ester component, detected by the above analysis results.

The compositional ratio of a polyester polycarbonate polyol including a dibasic acid can be obtained by using a value from subtraction of the same molar number of diol as the molar number of a dibasic acid-derived methyl ester to thereby determine the molar number of diol constituting a carbonate backbone (in a case where a plurality of diols are used, calculation is made based on the ratio of such diols determined with gas chromatography under the assumption that the compositional ratio in diol in a carbonate backbone and the compositional ratio in diol in an ester backbone are the same).

### <Measurement of Melt Viscosity>

After each polyester polycarbonate polyol or polyol was heated to 50° C. in advance, the melt viscosity was measured at 50° C. with a rotatory viscometer (an E-type viscometer (TVE-22HT manufactured by Toki Sangyo Co., Ltd., cone: No. 6)).

### <Carbonate Group Content of Polyester Polycarbonate Polyol>

The carbonate group content is an amount of a carbonate group contained in one molecule of a polyester polycarbonate polyol, and is specifically determined by the following expression (i).

$$Carbonate group content ( \% ) = ( Molecular weight of carbonate group ) \times ( Number of carbonate groups in one molecule ) / ( Number average molecular weight of polyester polycarbonate polyol ) \times 100 \qquad ( i )$$

wherein the molecular weight of a carbonate group (—O—C═O—O—) is 60.01.

The number of carbonate groups in one molecule was determined from the number (x) of repeating units in a carbonate structure by use of the following expression (9), based on a structure of the following formula (8):

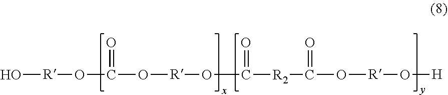

wherein R′ represents a linear methylene chain and/or a branch-containing methylene chain, and the average number of methylenes in R′ is defined as (m). x represents the number of repeating units in a carbonate structure backbone in one molecule, y represents the number of repeating units in an ester structure backbone, and each underlined portion represents a terminal group. R₂ represents a hydrocarbon derived from a dibasic acid used.

The structure of each segment constituting polycarbonate was determined from the compositional ratio of each polyester polycarbonate polyol determined from the Compositional ratio (ratio of copolymerization) of polyester polycarbonate polyol. Thus, the number of methylenes in each segment for constituting was determined, and the average number (m) of methylenes was determined from the ratio. In the case of a branch-containing methylene chain, calculation was made in consideration of the number of carbon atoms in branched methylene.

$$Number ( x ) of repeating units in carbonate group = [ ( Number average molecular weight ( Mn ) - ( Molecular weight of ester backbone ) - ( Molecular weight of terminal group ) ) / ( Molecular weight of repeating unit of carbonate backbone ) \qquad ( 9 )$$

The molecular weight of an ester backbone was determined from the compositional ratio of a carbonate backbone and the compositional ratio of an ester backbone, determined above with the gas chromatography. Specifically, the molecular weight of an ester backbone was the number obtained by multiplying the mass proportion obtained by conversion of the compositional ratio by mol of an ester backbone, determined separately with gas chromatography, into the compositional ratio by mass, with the molecular weight obtained by subtraction of the average molecular weight of a terminal diol group from the average molecular weight of the polyester polycarbonate polyol.

### <Form of Polyester Polycarbonate Polyol>

The form of the polyester polycarbonate polyol was determined by defining a state in which even a slight fluidity was exhibited at 23° C., as the form of a liquid, and a state in which no fluidity was exhibited, as the form of a solid.

### [Analysis and Evaluation of Polyurethane Film]

### <Production of Polyurethane Film>

A polyurethane solution in DMF was applied onto a polypropylene resin sheet (100 mm width, 1200 mm length, 1 mm thickness) by use of an applicator, and the resultant was dried on a hot plate at a surface temperature of 60° C. for 1 hour and subsequently in an oven at 80° C. for 24 hours. The resultant was further left to still stand under a constant-temperature and constant-humidity condition of 23° C. and 55% RH for 24 hours or more, to thereby obtain a polyurethane film having a thickness of about 50 μm. The polyurethane film obtained was subjected to evaluation of various physical properties.

### <Flexibility of Polyurethane Film>

The flexibility of the polyurethane film was evaluated by five examiners, and evaluated as touch in touching of the polyurethane film with their hands. The evaluation was performed according to the following criteria.
◯ means flexibleness, the evaluation results of the five examiners being consistent.
Δ means slight rigidity, the evaluation results of the five examiners being consistent.
x means rigidity, the evaluation results of the five examiners being consistent.

### <Appearance of Polyurethane Film>

The surface appearance of the polyurethane film produced as described above was visually rated according to the following criteria.
◯ means a smooth surface.
Δ means a few streaks observed on the surface in the movement direction of the applicator.
x means many streaks observed on the surface in the movement direction of the applicator.

### <Measurement of Molecular Weight>

The polyurethane film was partially cut out to prepare an N,N-dimethylacetamide solution so that the polyurethane concentration was 0.1% by mass, and the number average molecular weight (Mn) and weight average molecular weight (Mw) were measured in terms of standard polystyrene with a GPC apparatus [product name “HLC-8320” (columns: Tskgel Super HM-H×4) manufactured by Tosoh Corporation, a solution of 2.6 g of lithium bromide dissolved in 1 L of N,N-dimethylacetamide was used as an eluent].

### <Evaluation of Oleic Acid Resistance>

A test piece of 3 cm×3 cm was cut out from the polyurethane film, the weight of the test piece was measured by a precision balance, and thereafter the test piece was loaded into a glass bottle having a volume of 250 mL, into which 50 mL of oleic acid was placed as a test solvent, and was left to still stand in a constant-temperature bath at 80° C. under a nitrogen atmosphere for 24 hours. After the test, the test piece was taken out and the front and back surfaces thereof were lightly wiped by a paper wiper, thereafter weight measurement was performed with a precision balance, and the rate of change in weight (rate of increase) from that before the test was calculated. A rate of change in weight, closer to 0%, means more favorable oleic acid resistance. The rate of change in weight was rated according to the following criteria.
◯ means a case of a rate of change in weight of 11% or less.
Δ means a case of a rate of change in weight of more than 11% and 13% or less.
x means a rate of change in weight of more than 13%.

### <Measurement of Glass Transition Temperature (Tg)>

A test piece of 10 mm width, 40 mm length and about 50 μm thickness was cut out from the polyurethane film. A viscoelasticity measurement apparatus (manufactured by Hitachi High-Tech Science Corporation, [TA7000 series, DMA7100]) was used, the test piece was installed at a distance between chucks of 20 mm, and the viscoelasticity was measured at a rate of temperature rise of 5° C./min from −100° C. to 100° C. The peak of tan δ was read out, and the glass transition temperature (Tg) was determined.

### <Tensile Test at Room Temperature>

A polyurethane test piece was prepared as a strip of 10 mm width, 100 mm length and about 50 μm thickness, according to JIS K6301 (2010), a tensile test was performed at a distance between chucks of 20 mm, at a tensile speed of 100 mm/min and at a temperature of 23° C. (relative humidity 55%) with a tensile tester (product name “Tensilon, Model RTE-1210” manufactured by Orientec Co., Ltd.), and the stress (modulus at 100%) at 100% elongation of the test piece, and the strength at break and the elongation at break were measured.

### <Tensile Test at Low Temperature>

A polyurethane test piece was prepared as a strip of 10 mm width, 100 mm length and about 50 μm thickness, according to JIS K6301 (2010), and a film was placed at a distance between chucks of 20 mm in a tensile tester (product name “Tensilon, Model RTE-1210” manufactured by Orientec Co., Ltd.) equipped with a constant-temperature bath (“Model TLF-R3T-E-W” manufactured by Orientec Co., Ltd.). Subsequently, a tensile test was performed at a tensile speed of 100 mm/min after still standing at −20° C. for 5 minutes, and the stress at 5% elongation of the test piece (modulus at 5%), and the strength at break and the elongation at break were measured.

### <Evaluation of Heat Resistance>

The polyurethane film was formed into a strip of 10 mm width, 100 mm length and about 50 μm thickness, and heated in a gear oven at a temperature of 120° C. for 7 days. The breaking strength of the sample after heating was measured in the same manner as <Tensile test at room temperature>, and the percentage (%) of retention of breaking strength after heating relative to before heating was determined according to the following expression.

$$Percentage ( \% ) of retention of breaking strength = Breaking strength after heating / Breaking strength before heating \times 100$$

Evaluation was made according to the following criteria.
◯ means a case of a percentage of retention of breaking strength of 70% or more.
Δ means a case of a percentage of retention of breaking strength of 60% or more and less than 70%.
x means a case of a percentage of retention of breaking strength of less than 60%.

### <Evaluation of Hydrolysis Resistance>

The polyurethane film was formed into a strip of 10 mm width, 100 mm length and about 50 μm thickness, and heated in a constant-temperature and constant-humidity bath at a temperature of 85° C. and at a relative humidity of 85% for 14 days. The breaking strength of the sample after heating was measured in the same manner as <Tensile test at room temperature>, and the percentage (%) of retention of breaking strength after heating relative to before heating was determined according to the following expression.

$$Percentage ( \% ) of retention of breaking strength = Breaking strength after heating / Breaking strength before heating \times 100$$

Evaluation was made according to the following criteria.
◯ means a case of a percentage of retention of breaking strength of 70% or more.
Δ means a case of a percentage of retention of breaking strength of 55% or more and less than 70%.
x means a case of a percentage of retention of breaking strength of less than 55%.

### [Analysis and Evaluation of Synthetic Leather]

### <Flexibility of Synthetic Leather>

The flexibility of synthetic leather was evaluated by five examiners, and evaluated as touch in touching of the synthetic leather with their hands. The evaluation was performed according to the following criteria.
◯ means flexibleness, the evaluation results of the five examiners being consistent.
Δ means slight rigidity, the evaluation results of the five examiners being consistent.
x means rigidity, the evaluation results of the five examiners being consistent.

### <Appearance of Synthetic Leather>

The surface appearance of the synthetic leather produced as described above was visually rated according to the following criteria.
◯ means a smooth surface and a uniform grain pattern being observed.
Δ means a smooth surface, but any streak other than a grain pattern being observed.
x means streaks other than a grain pattern being observed on the surface, and a non-smooth surface and unevenness being observed.

### <Wear Resistance of Synthetic Leather>

A load of 9.8 N was applied to a friction block covered with a cotton cloth, to wear the surface of synthetic leather. The friction block was reciprocated for wearing within 140 mm on the surface of synthetic leather at a rate of 60 times/min for 10000 times. The synthetic leather after wearing was observed and rated according to the following criteria.
◯ means no cleavage or breakage in a resin layer.
Δ means any cleavage generated in a resin layer.
x means any breakage generated in a resin layer.

### <Low Temperature Storage Stability of Synthetic Leather>

Synthetic leather was wound on a paper tube having a diameter of 10 cm, and stored in a constant-temperature bath at a temperature of −20° C. for one month. The synthetic leather was removed from the paper tube, left to still stand in a constant-temperature room at a temperature of 23° C. and a humidity of 50% for one day, and the surface thereof was visually observed and evaluated according to the following criteria.
◯ means a case of no crack or wrinkle.
Δ means a case of any fine crack or wrinkle of 1 mm or less being observed.
x means a case of any crack or wrinkle of more than 1 mm being observed.

### <Low Temperature Flexibility (Cold-Resistant Flexibility) of Synthetic Leather>

A test piece of a size of a width of 5 cm and a length of 10 cm was obtained from the synthetic leather, and a low temperature flexibility test was performed 10000 times at a rate of 100 times/min with a Demacha flexibility tester (manufactured by Yasuda Seiki Seisakusho, Ltd.) at a temperature of −10° C. and a stroke of 15 mm. The test piece was taken out, and the surface thereof was visually observed and evaluated according to the following criteria.
◯ means a case of no crack or wrinkle.
Δ means a case of any fine crack or wrinkle of 1 mm or less being observed.
x means a case of any crack or wrinkle of more than 1 mm being observed or a case of peeling between the base fabric and the adhesion layer being observed.

### <Washing Resistance of Synthetic Leather>

A 1-cm square on the surface of synthetic leather was filled with oil paint (Magic Ink No. 500 manufactured by Teranishi Chemical Industry Co., Ltd.), and the resultant was dried for 4 hours and subjected to complete wiping off with a cotton ball impregnated with ethanol until any grime disappeared. The washing resistance was rated according to the following criteria.
◯ means a case of no crack or wrinkle being observed around the surface at all.
Δ means a case of a smooth surface, but any streak other than a grain pattern being observed.
x means a case of cracks, wrinkles, and streaks being observed on the surface and a non-smooth surface and unevenness being observed.

### <Method for Evaluating Adhesiveness>

An incision was made on the interface between a polyester base fabric and a polyurethane resin layer of synthetic leather in advance, the urethane resin layer peeled and the base fabric were each secured by chucks, and the peel strength between the polyurethane layer and the base fabric was measured at a temperature of 23° C. and at a speed of 200 mm/min with a tensile tester (product name “Tensilon, Model RTE-1210” manufactured by Orientec Co., Ltd.) with reference to JIS K6854-2, and evaluated according to the following criteria.
◯ means a case of 10 N/25 mm or more.
x means a case of less than 10 N/25 mm.

### <Hydrolysis Resistance of Synthetic Leather>

Synthetic leather was heated in advance in a constant-temperature and constant-humidity bath at a temperature of 85° C. and a relative humidity of 85% for 14 days, and the peel strength was measured in the same manner as in <Method for evaluating adhesiveness> and the percentage (%) of retention of peel strength after heating relative to before heating was determined by the following expression.

Percentage (%) of retention of peel strength=Peel strength after heating/Peel strength before heating×100

Evaluation was made according to the following criteria.
◯ means a case of a percentage of retention of peel strength of 70% or more.
Δ means a case of a percentage of retention of peel strength of 55% or more and less than 70%.
x means a case of a percentage of retention of peel strength of less than 55%.

### Example 1

### Synthesis Example 1 of Polyester Polycarbonate Polyol

A 1-L glass flask equipped with a stirring apparatus was loaded with 420 g of polycarbonate polyol (trade name “Duranol T5652”, manufactured by Asahi Kasei Corporation, number average molecular weight: about 2000, compositional ratio of diols: 1,5-pentanediol (hereinafter, also designated as “1,5-PDO”)/1,6-hexanediol (hereinafter, also designated as “1,6-HDO”)=50% by mol/50% by mol) and 180 g of polyester polyol (trade name “Kuraray Polyol P-2010”, manufactured by Kuraray Co., Ltd., number average molecular weight: about 2000, condensate of 3-methyl-1,5-pentanediol (hereinafter, also designated as “3MPD”) and adipic acid), heated under stirring and subjected to a reaction at a reactor temperature of about 175° C. for 10 hours, to obtain a polyester polycarbonate polyol (hereinafter, also designated as “PEC1”). PEC1 obtained was analyzed by 1H-NMR, and as a result, was confirmed to have a repeating unit represented by the following formula (1) and a repeating unit represented by the following formula (2), and have branch-containing 3MPD incorporated into R1 in the formula (1) and R3 in the formula (2) as a result of a transesterification reaction.

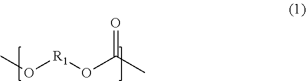

wherein R1 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, includes at least one branch-containing alkylene group having 4 to 15 carbon atoms, and includes at least one linear alkylene group having 2 to 10 carbon atoms.

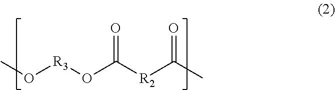

wherein R2 represents an alkylene group having 2 to 15 carbon atoms, and R3 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, includes at least one branch-containing alkylene group having 4 to 15 carbon atoms, and includes at least one linear alkylene group having 2 to 10 carbon atoms.

The results of analysis of PEC1 obtained were shown in Table 1.

### Example 2

### Synthesis Example 2 of Polyester Polycarbonate Polyol

A polyester polycarbonate polyol (hereinafter, also designated as “PEC2”) was obtained by the same reaction as in Example 1 by use of the same apparatus as in Example 1 except that 300 g of trade name “Duranol T5652” was used as a polycarbonate polyol and 300 g of trade name “Kuraray Polyol P-2010” was used as a polyester polyol. PEC2 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2). The results of analysis of PEC2 obtained were shown in Table 1.

### Example 3

### Synthesis Example 3 of Polyester Polycarbonate Polyol

A polyester polycarbonate polyol (hereinafter, also designated as “PEC3”) was obtained by the same reaction as in Example 1 by use of the same apparatus as in Example 1 except that trade name “Duranol G4672” (manufactured by Asahi Kasei Corporation, number average molecular weight: about 2000, compositional ratio of diols: 1,4-butanediol (hereinafter, also designated as “1,4-BDO”)/1,6-hexanediol=70% by mol/30% by mol) was used as a polycarbonate polyol. PEC3 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2). The results of analysis of PEC3 obtained were shown in Table 1.

### Example 4

### Synthesis Example 4 of Polyester Polycarbonate Polyol

A polyester polycarbonate polyol (hereinafter, also designated as “PEC4”) was obtained by the same reaction as in Example 1 by use of the same apparatus as in Example 1 except that trade name “Kuraray Polyol C-2090” (manufactured by Kuraray Co., Ltd., number average molecular weight: about 2000, compositional ratio of diols: 3-methyl-1,5-pentanediol/1,6-hexanediol=90% by mol/10% by mol) was used as a polycarbonate polyol and trade name “Polylite OD-X-668” (manufactured by DIC Corporation, number average molecular weight: about 2000, condensate of 1,4-butanediol and adipic acid) was used as a polyester polyol. PEC4 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2). The results of analysis of PEC4 obtained were shown in Table 1.

### Example 5

### Synthesis Example 5 of Polyester Polycarbonate Polyol

A 1-L glass flask equipped with a rectifier filled with a regular packing and a stirring apparatus was loaded with 293 g (3.33 mol) of ethylene carbonate, 275 g (3.05 mol) of 1,4-butanediol, and 57.2 g (0.33 mol) of 1,10-decanediol (hereinafter, also designated as “1,10-DDO”).

Thereto was added 0.06 g of titanium tetra-n-butoxide as a catalyst, and a reaction was performed for 12 hours while the reaction temperature was 150 to 170° C. and the pressure was dropped from 10 kPa to 3 kPa, and a mixture of ethylene glycol and ethylene carbonate generated was distilled off. Thereafter, switching to simple distillation was made, a monomer was distilled out by a reaction at 170° C. for 5 hours while the pressure was gradually reduced to 0.1 kPa, and a polycarbonate polyol (hereinafter, also designated as “PC1”) was obtained. The hydroxyl value was analyzed and thus was 57.1 mgKOH/g, and the ratio of copolymerization was analyzed and thus satisfied 1,4-butanediol/1,10-decanediol=90% by mol/10% by mol.

Next, a polyester polycarbonate polyol (hereinafter, also designated as “PEC5”) was obtained by the same reaction as in Example 1 by use of the same apparatus as in Example 1 except that 200 g of PC1 obtained by the above operation was used as a polycarbonate polyol and 200 g of trade name “Kuraray Polyol P-2010” was used as a polyester polyol. PEC5 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2). The results of analysis of PEC5 obtained were shown in Table 1.

### Example 6

### Synthesis Example 6 of Polyester Polycarbonate Polyol

A polyester polycarbonate polyol (hereinafter, also designated as “PEC6”) was obtained by the same reaction as in Example 1 by use of the same apparatus as in Example 1 except that 420 g of trade name “Duranol T6002” (manufactured by Asahi Kasei Corporation, number average molecular weight: about 2000, compositional ratio of diol: 1,6-hexanediol=100% by mol) was used as a polycarbonate polyol, and 120 g of trade name “Kuraray Polyol P-2010” and 60 g of trade name “Polylite OD-X-668” were used as polyester polyols. PEC6 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2). The results of analysis of PEC6 obtained were shown in Table 1.

### Example 7

### Synthesis Example 7 of Polyester Polycarbonate Polyol

A 1-L glass flask equipped with a rectifier filled with a regular packing and a stirring apparatus was loaded with 221 g (2.51 mol) of ethylene carbonate, 137 g (1.32 mol) of 1,5-pentanediol, 156 g (1.32 mol) of 1,6-hexanediol, 78.0 g (0.66 mol) of 3-methyl-1,5-pentanediol, and 90.6 g (0.62 mol) of adipic acid. Thereto was added 0.06 g of titanium tetra-n-butoxide as a catalyst, and a reaction was performed for 12 hours while the reaction temperature was 150 to 170° C. and the pressure was dropped from 10 kPa to 3 kPa, and a mixture of water, ethylene glycol and ethylene carbonate generated was distilled off. Thereafter, switching to simple distillation was made, and a monomer was distilled out by a reaction at 170° C. for 5 hours while the pressure was gradually reduced to 0.1 kPa. The results of analysis of the resulting polyester polycarbonate polyol (hereinafter, also designated as “PEC7”) were shown in Table 1. PEC7 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2).

### Example 8

### Synthesis Example 8 of Polyester Polycarbonate Polyol

A 1-L glass flask equipped with a rectifier filled with a regular packing and a stirring apparatus was loaded with 221 g (2.51 mol) of ethylene carbonate, 137 g (1.32 mol) of 1,5-pentanediol, 156 g (1.32 mol) of 1,6-hexanediol, 78.0 g (0.66 mol) of 3-methyl-1,5-pentanediol, and 90.6 g (0.62 mol) of adipic acid. Thereto was added 0.06 g of titanium tetra-n-butoxide as a catalyst, and a reaction was performed for 12 hours while the reaction temperature was 150 to 170° C. and the pressure was dropped from 10 kPa to 3 kPa, and a mixture of water, ethylene glycol and ethylene carbonate generated was distilled off. Thereafter, switching to simple distillation was made, and a monomer was distilled out by a reaction at 170° C. for 3 hours while the pressure was gradually reduced to 0.1 kPa. The results of analysis of the resulting polyester polycarbonate polyol (hereinafter, also designated as “PEC8”) were shown in Table 1. PEC8 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2).

### Example 9

### Synthesis Example 9 of Polyester Polycarbonate Polyol

A 1-L glass flask equipped with a rectifier filled with a regular packing and a stirring apparatus was loaded with 194 g (2.20 mol) of ethylene carbonate, 202 g (1.71 mol) of 1,6-hexanediol, 114 g (0.96 mol) of 3-methyl-1,5-pentanediol, 62.7 g (0.70 mol) of 2-methyl-1,3-propanediol (hereinafter, also designated as “2MPD”), and 131 g (0.89 mol) of adipic acid.

Thereto was added 0.10 g of titanium tetra-n-butoxide as a catalyst, and a reaction was performed for 15 hours while the reaction temperature was 150 to 170° C. and the pressure was dropped from 10 kPa to 3 kPa, and a mixture of water, ethylene glycol and ethylene carbonate generated was distilled off. Thereafter, switching to simple distillation was made, and a monomer was distilled out by a reaction at 170° C. for 5 hours while the pressure was gradually reduced to 0.1 kPa. The results of analysis of the resulting polyester polycarbonate polyol (hereinafter, also designated as “PEC9”) were shown in Table 1. PEC9 obtained was analyzed by 1H-NMR, and as a result, was confirmed to have the repeating unit represented by the formula (1) and the repeating unit represented by the formula (2), and have 2MPD and 3MPD incorporated into R1 in the formula (1) and R3 in the formula (2).

### Example 10

### Synthesis Example 10 of Polyester Polycarbonate Polyol

A polyester polycarbonate polyol (hereinafter, also designated as “PEC10”) was obtained by the same reaction as in Example 1 by use of the same apparatus as in Example 1 except that 420 g of trade name “Duranol T5652” was used as a polycarbonate polyol and 180 g of polyester polyol (trade name “Kuraray Polyol P-2050”, manufactured by Kuraray Co., Ltd., number average molecular weight: about 2000, condensate of 3MPD and sebacic acid) was used. PEC10 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2). The results of analysis of PEC10 obtained were shown in Table 1.

### Example 11

### Synthesis Example 11 of Polyester Polycarbonate Polyol

A 1-L glass flask equipped with a rectifier filled with a regular packing and a stirring apparatus was loaded with 205 g (2.33 mol) of ethylene carbonate, 187 g (2.46 mol) of 1,3-propanediol (hereinafter, also designated as “1,3-PDO”), 27.0 g (0.30 mol) of 1,4-butanediol, 63.1 g (0.53 mol) of 3-methyl-1,5-pentanediol, and 113 g (0.78 mol) of adipic acid. Thereto was added 0.05 g of titanium tetra-n-butoxide as a catalyst, and a reaction was performed for 18 hours while the reaction temperature was 150 to 170° C. and the pressure was dropped from 10 kPa to 3 kPa, and a mixture of water, ethylene glycol and ethylene carbonate generated was distilled off. Thereafter, switching to simple distillation was made, and a monomer was distilled out by a reaction at 170° C. for 5 hours while the pressure was gradually reduced to 0.1 kPa. The results of analysis of the resulting polyester polycarbonate polyol (hereinafter, also designated as “PEC11”) were shown in Table 1. PEC11 obtained was analyzed by 1H-NMR, and as a result, was confirmed to have the repeating unit represented by the formula (1) and the repeating unit represented by the formula (2), and have 3MPD incorporated into R1 in the formula (1) and R3 in the formula (2).

### Comparative Example 1

### Synthesis Example 12 of Polyester Polycarbonate Polyol

A polyester polycarbonate polyol (hereinafter, also designated as “PEC12”) was obtained by the same reaction as in Example 1 by use of the same apparatus as in Example 1 except that 420 g of trade name “Duranol T5652” was used as a polycarbonate polyol and 180 g of trade name “Polylite OD-X-2640” (manufactured by DIC Corporation, number average molecular weight: about 2000, condensate of 1,6-hexanediol and adipic acid) was used as a polyester polyol. The results of analysis of PEC12 obtained were shown in Table 1. No branch-containing alkylene group-derived diol was confirmed in the compound.

### Comparative Example 2

### Synthesis Example 13 of Polyester Polycarbonate Polyol

A polyester polycarbonate polyol (hereinafter, also designated as “PEC13”) was obtained by the same reaction as in Example 1 by use of the same apparatus as in Example 1 except that trade name “Duranol T6002” was used as a polycarbonate polyol and trade name “Polylite OD-X-668” was used as a polyester polyol. The results of analysis of PEC13 obtained were shown in Table 1. The compound was a solid at ordinary temperature, and no branch-containing alkylene group-derived diol was confirmed.

### Comparative Example 3

### Synthesis Example 14 of Polyester Polycarbonate Polyol

A polyester polycarbonate polyol (hereinafter, also designated as “PEC14”) was obtained by the same reaction as in Example 1 by use of the same apparatus as in Example 1 except that trade name “Duranol T6002” was used as a polycarbonate polyol and trade name “Polylite OD-X-2640” was used as a polyester polyol. The results of analysis of PEC14 obtained were shown in Table 1. The compound was a solid at ordinary temperature, and no branch-containing alkylene group-derived diol was confirmed.

### Comparative Example 4

### Synthesis Example 15 of Polyester Polycarbonate Polyol

A 1-L glass flask equipped with a rectifier filled with a regular packing and a stirring apparatus was loaded with 221 g (2.51 mol) of ethylene carbonate, 137 g (1.32 mol) of 1,5-pentanediol, 156 g (1.32 mol) of 1,6-hexanediol, 78.0 g (0.66 mol) of 3-methyl-1,5-pentanediol, and 90.6 g (0.62 mol) of adipic acid. Thereto was added 0.06 g of titanium tetra-n-butoxide as a catalyst, and a reaction was performed for 12 hours while the reaction temperature was 150 to 170° C. and the pressure was dropped from 10 kPa to 3 kPa, and a mixture of water, ethylene glycol and ethylene carbonate generated was distilled off. Thereafter, switching to simple distillation was made, and a monomer was distilled out by a reaction at 170° C. for 2.5 hours while the pressure was gradually reduced to 0.1 kPa. The results of analysis of the resulting polyester polycarbonate polyol (hereinafter, also designated as “PEC15”) were shown in Table 1.

### Comparative Example 5

### Synthesis Example 16 of Polyester Polycarbonate Polyol

A 1-L glass flask equipped with a rectifier filled with a regular packing and a stirring apparatus was loaded with 221 g (2.51 mol) of ethylene carbonate, 137 g (1.32 mol) of 1,5-pentanediol, 156 g (1.32 mol) of 1,6-hexanediol, 78.0 g (0.66 mol) of 3-methyl-1,5-pentanediol, and 90.6 g (0.62 mol) of adipic acid. Thereto was added 0.06 g of titanium tetra-n-butoxide as a catalyst, and a reaction was performed for 12 hours while the reaction temperature was 150 to 170° C. and the pressure was dropped from 10 kPa to 3 kPa, and a mixture of water, ethylene glycol and ethylene carbonate generated was distilled off. Thereafter, switching to simple distillation was made, and a monomer was distilled out by a reaction at 170° C. for 6.5 hours while the pressure was gradually reduced to 0.1 kPa. The results of analysis of the resulting polyester polycarbonate polyol (hereinafter, also designated as “PEC16”) were shown in Table 1.

### Comparative Example 6

### Synthesis Example 17 of Polyester Polycarbonate Polyol

A polyester polycarbonate polyol (hereinafter, also designated as “PEC17”) was obtained by the same reaction as in Example 1 except that a 1-L glass flask equipped with a rectifier filled with a regular packing and a stirring apparatus was loaded with 300 g of trade name “Durarol T5652” as a polycarbonate polyol and 300 g of trade name “Polylite OD-X-2640” as a polyester polyol. The results of analysis of PEC17 obtained were shown in Table 1. No branch-containing alkylene group-derived diol was confirmed in the compound.

TABLE 1

| | | Physical properties of polyester polycarbonate polyol | | | | | | | | |
|---|---|---|---|---|---|---|---|---|---|---|
| | | | Melt | Hydroxyl | Average | Carbonate | Molar ratio of constituent components of | | | |
| | | Appearance | viscosity | value | molecular | group | polyester polycarbonate polyol | | | |
| | | at | at 50° C. | (mgKOH/ | weight | content (% | 1,3- | 1,4- | 1,5- | 1,6- |
| | Type | 23° C. | (mPa · s) | g) | (g/mol) | by mass) | PDO | BDO | PDO | HDO |
| Example 1 | PEC1 | Form of liquid | 5290 | 56.6 | 1982 | 29.5% | 0 | 0 | 0.20 | 0.20 |
| Example 2 | PEC2 | Form of liquid | 3410 | 54.9 | 2044 | 20.4% | 0 | 0 | 0.16 | 0.16 |
| Example 3 | PEC3 | Form of liquid | 7730 | 56.5 | 1986 | 32.6% | 0 | 0.29 | 0 | 0.13 |
| Example 4 | PEC4 | Form of liquid | 4290 | 56.2 | 1996 | 27.7% | 0 | 0.13 | 0 | 0.04 |
| Example 5 | PEC5 | Form of liquid | 8900 | 56.8 | 1975 | 23.4% | 0 | 0.30 | 0 | 0 |
| Example 6 | PEC6 | Form of liquid | 5530 | 56.5 | 1986 | 27.9% | 0 | 0.04 | 0 | 0.40 |
| Example 7 | PEC7 | Form of liquid | 5300 | 56.2 | 1996 | 29.3% | 0 | 0 | 0.20 | 0.20 |
| Example 8 | PEC8 | Form of liquid | 2460 | 76.1 | 1474 | 29.2% | 0 | 0 | 0.21 | 0.21 |
| Example 9 | PEC9 | Form of liquid | 7800 | 57.9 | 1938 | 26.1% | 0 | 0 | 0 | 0.26 |
| Example 10 | PEC10 | Form of liquid | 5520 | 56.3 | 1993 | 29.3% | 0 | 0 | 0.21 | 0.21 |
| Example 11 | PEC11 | Form of liquid | 7100 | 55.2 | 2033 | 33.7% | 0.38 | 0.05 | 0 | 0 |
| Comparative | PEC12 | Form of liquid | 5170 | 55.5 | 2022 | 28.9% | 0 | 0 | 0.21 | 0.31 |
| Example 1 | | | | | | | | | | |
| Comparative | PEC13 | Form of solid | 6430 | 56.4 | 1989 | 27.8% | 0 | 0.13 | 0 | 0.39 |
| Example 2 | | | | | | | | | | |
| Comparative | PEC14 | Form of solid | 5160 | 56.5 | 1986 | 27.9% | 0 | 0 | 0 | 0.52 |
| Example 3 | | | | | | | | | | |
| Comparative | PEC15 | Form of liquid | 1350 | 110.2 | 1018 | 27.3% | 0 | 0 | 0.21 | 0.21 |
| Example 4 | | | | | | | | | | |
| Comparative | PEC16 | Form of liquid | 14100 | 33.3 | 3369 | 29.8% | 0 | 0 | 0.21 | 0.21 |
| Example 5 | | | | | | | | | | |
| Comparative | PEC17 | Form of liquid | 3320 | 56.2 | 1996 | 20.9% | 0 | 0 | 0.16 | 0.36 |
| Example 6 | | | | | | | | | | |
| | | | | | | | Molar ratio | | Mass ratio | |
| | | | | | | | Formula | | Formula | |
| | Molar ratio of constituent components of polyester polycarbonate polyol | | | | | | (1)/ | | (1)/ | |
| | 1,10- | | | Adipic | Sebacic | Carbonate | Formula | | Formula | |
| | DDO | 2MPD | 3MPD | acid | acid | backbone | (2) | | (2) | |
| Example 1 | 0 | 0 | 0.11 | 0.10 | 0 | 0.38 | 71 | 29 | 80 | 20 |
| Example 2 | 0 | 0 | 0.20 | 0.18 | 0 | 0.30 | 51 | 49 | 63 | 37 |
| Example 3 | 0 | 0 | 0.10 | 0.09 | 0 | 0.39 | 72 | 28 | 81 | 19 |
| Example 4 | 0 | 0 | 0.35 | 0.11 | 0 | 0.37 | 66 | 34 | 76 | 24 |
| Example 5 | 0.03 | 0 | 0.19 | 0.17 | 0 | 0.31 | 53 | 47 | 65 | 35 |
| Example 6 | 0 | 0 | 0.08 | 0.11 | 0 | 0.37 | 70 | 30 | 79 | 21 |
| Example 7 | 0 | 0 | 0.11 | 0.10 | 0 | 0.38 | 71 | 29 | 80 | 20 |
| Example 8 | 0 | 0 | 0.11 | 0.10 | 0 | 0.38 | 71 | 29 | 80 | 20 |
| Example 9 | 0 | 0.11 | 0.15 | 0.14 | 0 | 0.34 | 61 | 39 | 72 | 28 |
| Example 10 | 0 | 0 | 0.09 | 0 | 0.08 | 0.40 | 71 | 29 | 83 | 17 |
| Example 11 | 0 | 0 | 0.08 | 0.12 | 0 | 0.36 | 66 | 34 | 77 | 23 |
| Comparative | 0 | 0 | 0 | 0.10 | 0 | 0.38 | 71 | 29 | 80 | 20 |
| Example 1 | | | | | | | | | | |
| Comparative | 0 | 0 | 0 | 0.11 | 0 | 0.37 | 66 | 34 | 76 | 24 |
| Example 2 | | | | | | | | | | |
| Comparative | 0 | 0 | 0 | 0.10 | 0 | 0.38 | 70 | 30 | 79 | 21 |
| Example 3 | | | | | | | | | | |
| Comparative | 0 | 0 | 0.12 | 0.09 | 0 | 0.37 | 71 | 29 | 80 | 20 |
| Example 4 | | | | | | | | | | |
| Comparative | 0 | 0 | 0.10 | 0.09 | 0 | 0.40 | 73 | 27 | 81 | 19 |
| Example 5 | | | | | | | | | | |
| Comparative | 0 | 0 | 0 | 0.18 | 0 | 0.30 | 51 | 49 | 63 | 37 |
| Example 6 | | | | | | | | | | |

### Example 12

A 500-mL separable flask with a stirring blade, sealed with nitrogen gas, was loaded with 15.3 g (0.06 mol) of diphenylmethane-4,4′-diisocyanate (MDI, average number of isocyanate groups in one molecule: 2.0) and 80.0 g of N,N-dimethylformamide (DMF), and the resultant was warmed to 40° C. to thereby obtain a solution. 60 g of N,N-dimethylformamide (DMF), and 40.0 g (0.02 mol) of polyester polycarbonate polyol PEC1 to which 2.8 mg of dibutyltin dilaurate as a catalyst was added, were dropped to the flask under stirring of the solution over 30 minutes. The reaction was made at 40° C. under stirring for 2 hours, to obtain a prepolymer with isocyanate at a terminal. Next, 3.6 g (0.04 mol) of 1,4-butanediol (BDO) as a chain extender was added, the temperature was raised to 60° C. to perform a reaction for 1 hour, and thereafter 0.5 g of ethanol as a reaction terminator was added to thereby obtain a polyurethane solution in DMF (solid content: about 30% by mass). The polyurethane solution in DMF obtained (curable composition) was used to produce a polyurethane film according to the procedure in <Production of polyurethane film>. The evaluation results were shown in Table 2.

### Examples 13 to 22

Each polyurethane film was obtained in the same manner as in Example 12 except that PEC2 to PEC11 were each used as the polyester polycarbonate polyol, the mass of the polyester polycarbonate polyol used was the mass described in Table 2, and the amount of DMF was adjusted so that the solid content was about 30% by mass, and was subjected to evaluation of various physical properties. The evaluation results were shown in Table 2.

### Comparative Examples 7 to 12

Each polyurethane film was obtained in the same manner as in Example 12 except that PEC12 to PEC17 were each used as the polyester polycarbonate polyol, the mass of the polyester polycarbonate polyol used was the mass described in Table 2, and the amount of DMF was adjusted so that the solid content was about 30% by mass, and was subjected to evaluation of various physical properties. The evaluation results were shown in Table 2.

TABLE 2

| | Ex. | Ex. | Ex. | Ex. | Ex. | Ex. | Ex. | Ex. | Ex. |
|---|---|---|---|---|---|---|---|---|---|
| | 12 | 13 | 14 | 15 | 16 | 17 | 18 | 19 | 20 |
| Type of polyester | PEC1 | PEC2 | PEC3 | PEC4 | PEC5 | PEC6 | PEC7 | PEC8 | PEC9 |
| polycarbonate polyol | | | | | | | | | |
| Mass of polyester | 40.0 | 40.0 | 40.0 | 40.0 | 40.0 | 40.0 | 40.0 | 29.5 | 40.0 |
| polycarbonate polyol (g) | | | | | | | | | |
| Organic polyisocyanate | MDI | MDI | MDI | MDI | MDI | MDI | MDI | MDI | MDI |
| compound | | | | | | | | | |
| Chain extender | BDO | BDO | BDO | BDO | BDO | BDO | BDO | BDO | BDO |
| Number average | 72000 | 71000 | 69000 | 65000 | 58000 | 69000 | 77000 | 74000 | 74000 |
| molecular weight | | | | | | | | | |
| (Mn) of polyurethane | | | | | | | | | |
| <Tensile properties> | | | | | | | | | |
| Strength at break (MPa) | 60.2 | 52.2 | 68.6 | 50.7 | 68.2 | 51.0 | 59.6 | 69.3 | 65.4 |
| Elongation at break (%) | 865 | 845 | 736 | 777 | 829 | 813 | 873 | 603 | 667 |
| Modulus at 100% (MPa) | 4.6 | 4.4 | 5.3 | 4.9 | 5.5 | 4.3 | 4.6 | 6.3 | 5.1 |
| <Tensile properties at low | | | | | | | | | |
| temperature (−20° C.)> | | | | | | | | | |
| Strength at break (MPa) | 75.3 | 78.9 | 88.5 | 60.2 | 74.6 | 81.4 | 73.1 | 78.8 | 78.4 |
| Elongation at break (%) | 615 | 730 | 508 | 552 | 513 | 460 | 619 | 464 | 512 |
| Modulus at 5% (MPa) | 3.4 | 2.1 | 3.8 | 3.6 | 4.1 | 3.8 | 3.4 | 17.4 | 3.8 |
| Tg (° C.) of polyurethane | −12 | −17 | −9 | −14 | −8 | −16 | −12 | −4 | −10 |
| Oleic acid resistance | 9.9 | 11.7 | 8.9 | 10.0 | 9.7 | 9.5 | 9.6 | 8.8 | 8.8 |
| Rate of change | | | | | | | | | |
| in weight (%) | | | | | | | | | |
| Heat resistance | 87.4 | 97.0 | 91.8 | 84.4 | 93.8 | 76.1 | 87.0 | 89.2 | 84.7 |
| Percentage of retention | | | | | | | | | |
| of breaking strength (%) | | | | | | | | | |
| Hydrolysis resistance | 86.0 | 57.8 | 88.6 | 79.5 | 85.9 | 63.2 | 89.5 | 88.8 | 87.1 |
| Percentage of retention | | | | | | | | | |
| of breaking strength (%) | | | | | | | | | |
| Flexibility of | ◯ | ◯ | ◯ | ◯ | ◯ | ◯ | ◯ | ◯ | ◯ |
| polyurethane film | | | | | | | | | |
| Appearance of | ◯ | ◯ | ◯ | ◯ | ◯ | ◯ | ◯ | ◯ | ◯ |
| polyurethane film | | | | | | | | | |

| | Ex. | Ex. | Comp. | Comp. | Comp. | Comp. | Comp. | Comp. |
|---|---|---|---|---|---|---|---|---|
| | 21 | 22 | Ex. 7 | Ex. 8 | Ex. 9 | Ex. 10 | Ex. 11 | Ex. 12 |
| Type of polyester | PEC10 | PEC11 | PEC12 | PEC 13 | PEC14 | PEC15 | PEC16 | PEC 17 |
| polycarbonate polyol | | | | | | | | |
| Mass of polyester | 40.0 | 40.0 | 40.0 | 40.0 | 40.0 | 20.2 | 66.7 | 40.0 |
| polycarbonate polyol (g) | | | | | | | | |
| Organic polyisocyanate | MDI | MDI | MDI | MDI | MDI | MDI | MDI | MDI |
| compound | | | | | | | | |
| Chain extender | BDO | BDO | BDO | BDO | BDO | BDO | BDO | BDO |
| Number average | 66000 | 79000 | 72000 | 52000 | 63000 | 51000 | 56000 | 68000 |
| molecular weight | | | | | | | | |
| (Mn) of polyurethane | | | | | | | | |
| <Tensile properties> | | | | | | | | |
| Strength at break (MPa) | 59.2 | 54.7 | 44.1 | 67.5 | 69.9 | 63.7 | 55.3 | 40.5 |
| Elongation at break (%) | 913 | 919 | 891 | 704 | 769 | 530 | 880 | 910 |
| Modulus at 100% (MPa) | 4.2 | 5.0 | 4.0 | 5.1 | 4.6 | 19.4 | 3.1 | 3.8 |
| <Tensile properties at low | | | | | | | | |
| temperature (−20° C.)> | | | | | | | | |
| Strength at break (MPa) | 70.4 | 74.8 | 81.1 | 82.2 | 83.4 | 84.6 | 65.3 | 74.7 |
| Elongation at break (%) | 694 | 686 | 468 | 444 | 437 | 430 | 700 | 512 |
| Modulus at 5% (MPa) | 3.0 | 18.6 | 3.9 | 4.0 | 4.0 | 44.4 | 2.3 | 2.6 |
| Tg (° C.) of polyurethane | −15 | −5 | −15 | −17 | −18 | 20 | −31 | −20 |
| Oleic acid resistance | 12.1 | 9.1 | 10.0 | 9.0 | 10.1 | 10.2 | 15.8 | 11.9 |
| Rate of change | | | | | | | | |
| in weight (%) | | | | | | | | |
| Heat resistance | 94.4 | 88.3 | 70.9 | 89.0 | 58.7 | 83.6 | 87.7 | 75.4 |
| Percentage of retention | | | | | | | | |
| of breaking strength (%) | | | | | | | | |
| Hydrolysis resistance | 87.2 | 79.8 | 69.2 | 52.6 | 61.5 | 72.4 | 69.3 | 41.8 |
| Percentage of retention | | | | | | | | |
| of breaking strength (%) | | | | | | | | |
| Flexibility of | ◯ | ◯ | ◯ | ◯ | ◯ | X | ◯ | ◯ |
| polyurethane film | | | | | | | | |
| Appearance of | ◯ | ◯ | ◯ | ◯ | ◯ | ◯ | Δ | ◯ |
| polyurethane film | | | | | | | | |

MDI: Diphenylmethane-4,4′-diisocyanate
BDO: 1.4-Butanediol

### Example 23

A 500-mL separable flask with a stirring blade, sealed with nitrogen gas, was loaded with 15.7 g (0.06 mol) of 4,4′-methylenebiscyclohexyl diisocyanate (hydrogenated MDI, average number of isocyanate groups in one molecule: 2.0) and 80 g of N,N-dimethylformamide (DMF), and the resultant was warmed to 50° C. to thereby obtain a solution. 60 g of N,N-dimethylformamide (DMF), and 40 g (0.02 mol) of polyester polycarbonate polyol PEC1 to which 2.8 mg of dibutyltin dilaurate as a catalyst was added, were dropped to the flask under stirring of the solution over 30 minutes. The reaction was made at 70° C. under stirring for 2 hours, to obtain a prepolymer with isocyanate at a terminal. Next, 6.8 g (0.04 mol) of isophoronediamine (IPDA) as a chain extender was added to perform a reaction at 70° C. for 2 hours, and thereafter 0.5 g of ethanol as a reaction terminator was added to thereby obtain a polyurethane solution in DMF (solid content: about 30% by mass). The polyurethane solution in DMF obtained (curable composition) was used to produce a polyurethane film according to the procedure in <Production of polyurethane film>. The evaluation results were shown in Table 3.

### Examples 24 to 32

Each polyurethane film was obtained in the same manner as in Example 23 except that PEC2 to 11 were each used as the polyester polycarbonate polyol, the mass of the polyester polycarbonate polyol used was the mass described in Table 3, and the amount of DMF was adjusted so that the solid content was about 30% by mass, and was subjected to evaluation of various physical properties. The evaluation results were shown in Table 3.

### Comparative Examples 13 to 18

Each polyurethane film was obtained in the same manner as in Example 23 except that PEC12 to 17 were each used as the polyester polycarbonate polyol, the mass of the polyester polycarbonate polyol used was the mass described in Table 3, and the amount of DMF was adjusted so that the solid content was about 30% by mass, and was subjected to evaluation of various physical properties. The evaluation results were shown in Table 3.

TABLE 3

| | Example | Example | Example | Example | Example | Example | Example | Example |
|---|---|---|---|---|---|---|---|---|
| | 23 | 24 | 25 | 26 | 27 | 28 | 29 | 30 |
| Type of polyester | PEC1 | PEC2 | PEC3 | PEC4 | PEC5 | PEC6 | PEC8 | PEC9 |
| polycarbonate polyol | | | | | | | | |
| Mass of polyester | 40.0 | 40.0 | 40.0 | 40.0 | 40.0 | 40.0 | 30.0 | 40.0 |
| polycarbonate polyol (g) | | | | | | | | |
| Organic polyisocyanate | Hydro- | Hydro- | Hydro- | Hydro- | Hydro- | Hydro- | Hydro- | Hydro- |
| compound | genated | genated | genated | genated | genated | genated | genated | genated |
| | MDI | MDI | MDI | MDI | MDI | MDI | MDI | MDI |
| Chain extender | IPDA | IPDA | IPDA | IPDA | IPDA | IPDA | IPDA | IPDA |
| Number average molecular | 52000 | 53000 | 53000 | 61000 | 63000 | 59000 | 46000 | 64000 |
| weight (Mn) of polyurethane | | | | | | | | |
| <Tensile properties> | | | | | | | | |
| Strength at break (MPa) | 62.5 | 62.1 | 68.2 | 53.1 | 70.4 | 53.1 | 70.5 | 67.4 |
| Elongation at break (%) | 807 | 799 | 715 | 733 | 813 | 778 | 543 | 652 |
| Modulus at 100% (MPa) | 4.9 | 4.6 | 5.6 | 5.3 | 5.8 | 4.6 | 6.6 | 6.2 |
| <Tensile properties at low | | | | | | | | |
| temperature (−20° C.)> | | | | | | | | |
| Strength at break (MPa) | 38.4 | 41.3 | 44.1 | 24.6 | 37.8 | 45.4 | 42.7 | 39.7 |
| Elongation at break (%) | 600 | 647 | 516 | 533 | 491 | 442 | 434 | 514 |
| Modulus at 5% (MPa) | 7.1 | 5.9 | 8.1 | 6.8 | 9.1 | 7.0 | 21.5 | 7.7 |
| Tg (° C.) of polyurethane | −5 | −10 | −3 | -9 | −2 | −9 | 1 | −5 |
| Oleic acid resistance | 10.6 | 11.0 | 9.9 | 10.5 | 10.4 | 10.5 | 9.8 | 9.7 |
| Rate of change in weight (%) | | | | | | | | |
| Heat resistance | 82.3 | 93.7 | 81.4 | 78.5 | 89.5 | 71.6 | 84.7 | 79.9 |
| Percentage of retention of | | | | | | | | |
| breaking strength (%) | | | | | | | | |
| Hydrolysis resistance | 86.7 | 66.6 | 84.5 | 79.7 | 87.2 | 63.2 | 85.8 | 88.3 |
| Percentage of retention of | | | | | | | | |
| breaking strength (%) | | | | | | | | |
| Flexibility of polyurethane film | ◯ | ◯ | ◯ | ◯ | ◯ | ◯ | Δ | ◯ |
| Appearance of polyurethane | ◯ | ◯ | ◯ | ◯ | ◯ | ◯ | ◯ | ◯ |
| film | | | | | | | | |
| | Example | Example | Comp. | Comp. | Comp. | Comp. | Comp. | Comp. |
| | 31 | 32 | Ex. 13 | Ex. 14 | Ex. 15 | Ex. 16 | Ex. 17 | Ex. 18 |
| Type of polyester | PEC10 | PEC11 | PEC12 | PEC13 | PEC14 | PEC15 | PEC16 | PEC17 |
| polycarbonate polyol | | | | | | | | |
| Mass of polyester | 40.0 | 40.0 | 40.0 | 40.0 | 40.0 | 20.4 | 68.5 | 40.0 |
| polycarbonate polyol (g) | | | | | | | | |
| Organic polyisocyanate | Hydro- | Hydro- | Hydro- | Hydro- | Hydro- | Hydro- | Hydro- | Hydro- |
| compound | genated | genated | genated | genated | genated | genated | genated | genated |
| | MDI | MDI | MDI | MDI | MDI | MDI | MDI | MDI |
| Chain extender | IPDA | IPDA | IPDA | IPDA | IPDA | IPDA | IPDA | IPDA |
| Number average molecular | 52000 | 54000 | 49000 | 50000 | 54000 | 50000 | 58000 | 51000 |
| weight (Mn) of polyurethane | | | | | | | | |
| <Tensile properties> | | | | | | | | |
| Strength at break (MPa) | 55.5 | 55.8 | 44.7 | 67.5 | 63.9 | 67.4 | 49.6 | 47.1 |
| Elongation at break (%) | 817 | 871 | 838 | 569 | 742 | 513 | 826 | 894 |
| Modulus at 100% (MPa) | 4.8 | 6.4 | 4.8 | 5.6 | 13.6 | 24.0 | 7.4 | 4.6 |
| <Tensile properties at low | | | | | | | | |
| temperature (−20° C.)> | | | | | | | | |
| Strength at break (MPa) | 39.1 | 44.6 | 41.4 | 56.8 | 26.7 | 44.6 | 24.9 | 39.5 |
| Elongation at break (%) | 624 | 397 | 460 | 133 | 320 | 347 | 605 | 547 |
| Modulus at 5% (MPa) | 6.3 | 20.8 | 7.7 | 6.9 | 7.5 | 39.1 | 3.5 | 6.6 |
| Tg (° C.) of polyurethane | −8 | 1 | −6 | −9 | −7 | 23 | −27 | −9 |
| Oleic acid resistance | 12.7 | 9.6 | 10.0 | 9.0 | 10.1 | 10.8 | 16.9 | 11.6 |
| Rate of change in weight (%) | | | | | | | | |
| Heat resistance | 92.2 | 79.4 | 64.5 | 83.3 | 57.6 | 81.1 | 81.1 | 68.4 |
| Percentage of retention of | | | | | | | | |
| breaking strength (%) | | | | | | | | |
| Hydrolysis resistance | 88.1 | 71.4 | 61.4 | 33.0 | 58.3 | 64.9 | 50.3 | 43.3 |
| Percentage of retention of | | | | | | | | |
| breaking strength (%) | | | | | | | | |
| Flexibility of polyurethane film | ◯ | ◯ | ◯ | ◯ | ◯ | X | ◯ | ◯ |
| Appearance of polyurethane | ◯ | ◯ | ◯ | ◯ | ◯ | ◯ | ◯ | ◯ |
| film | | | | | | | | |

Hydrogenated MDI: Diphenylmethane-4,4′-diisocyanate
IPDA: Isophoronediamine

### Example 33

### (Production of Synthetic Leather)

The same apparatus as the apparatus illustrated in FIG. 2 was used, release paper (manufactured by LINTEC Corporation, R-8) having an embossed pattern was used, and a composition having the same compositional ratio as in Example 23 (two components, a prepolymer obtained by a reaction of isocyanate and the polyester polycarbonate polyol, and a chain extender, were continuously mixed by a mixing head at a temperature of 70° C. at the last time) was allowed to continuously flow down on the release paper, and adjusted by a coating roll so that the thickness was 50 μm. The resultant was allowed to pass through a drier at 120° C., to form a urethane layer serving as a skin layer. Thus, in the present embodiment, the amount of a solvent used in production of synthetic leather from a polyurethane produced can be decreased and production with no solvent can be achieved.

Next, a composition having the same compositional ratio as in Example 12 (two components, a prepolymer obtained by a reaction of isocyanate and the polyester polycarbonate polyol, and a chain extender, were continuously mixed by a mixing head at a temperature of 40° C. at the last time) was allowed to continuously flow down on the release paper, and adjusted by a coating roll so that the thickness was 250 μm. The resultant was allowed to pass through a drier at 120° C., to form a urethane layer serving as an adhesion layer.

Next, synthetic leather including a polyurethane laminate was obtained by laminating the adhesion layer and a base fabric (non-woven fabric including a polyester fiber) having a thickness of 500 μm by a pressure bonding roll, and winding the resultant by a winding roll. The synthetic leather obtained was evaluated and the results were shown in Table 4.

### Examples 34 to 42

Each synthetic leather including a polyurethane laminate was obtained in the same manner as in Example 33 except that the type of polyurethane serving as the skin layer and the type of polyurethane serving as the adhesion layer were changed as shown in Table 4. The synthetic leather obtained was evaluated and the results were shown in Table 4.

### Comparative Examples 19 to 24

Each synthetic leather including a polyurethane laminate was obtained in the same manner as in Example 33 except that the type of polyurethane serving as the skin layer and the type of polyurethane serving as the adhesion layer were changed as shown in Table 4. The synthetic leather obtained was evaluated and the results were shown in Table 4.

TABLE 4

| | Example | Example | Example | Example | Example | Example | Example | Example |
|---|---|---|---|---|---|---|---|---|
| Synthetic leather | 33 | 34 | 35 | 36 | 37 | 38 | 39 | 40 |
| Composition ratio of polyurethane for | Example | Example | Example | Example | Example | Example | Example | Example |
| skin layer | 23 | 24 | 25 | 26 | 27 | 28 | 29 | 30 |
| Composition ratio of polyurethane for | Example | Example | Example | Example | Example | Example | Example | Example |
| adhesion layer | 12 | 13 | 14 | 15 | 16 | 17 | 19 | 20 |
| Flexibility of synthetic leather | ◯ | ◯ | ◯ | ◯ | ◯ | ◯ | ◯ | ◯ |
| Appearance of synthetic leather | ◯ | ◯ | ◯ | ◯ | ◯ | ◯ | ◯ | ◯ |
| Wear resistance | ◯ | ◯ | ◯ | ◯ | ◯ | ◯ | ◯ | ◯ |
| Low temperature storage stability | ◯ | ◯ | ◯ | ◯ | ◯ | ◯ | ◯ | ◯ |
| Cold-resistant flexibility | ◯ | ◯ | ◯ | ◯ | ◯ | ◯ | Δ | ◯ |
| Washing resistance | ◯ | ◯ | ◯ | ◯ | Δ | ◯ | ◯ | Δ |
| Adhesiveness (peel strength (N/25 | 18 | 21 | 15 | 14 | 11 | 16 | 15 | 13 |
| mm) between polyurethane layer | | | | | | | | |
| and base fabric) | | | | | | | | |
| Hydrolysis resistance | ◯ | Δ | ◯ | ◯ | Δ | ◯ | ◯ | Δ |
| | Example | Example | Comp. | Comp. | Comp. | Comp. | Comp. | Comp. |
| Synthetic leather | 41 | 42 | Ex. 19 | Ex. 20 | Ex. 21 | Ex. 22 | Ex. 23 | Ex. 24 |
| Composition ratio of polyurethane for | Example | Example | Comp. | Comp. | Comp. | Comp. | Comp. | Comp. |
| skin layer | 31 | 32 | Ex. 13 | Ex. 14 | Ex. 15 | Ex. 16 | Ex. 17 | Ex. 18 |
| Composition ratio of polyurethane for | Example | Example | Comp. | Comp. | Comp. | Comp. | Comp. | Comp. |
| adhesion layer | 21 | 22 | Ex. 7 | Ex. 8 | Ex. 9 | Ex. 10 | Ex. 11 | Ex. 12 |
| Flexibility of synthetic leather | ◯ | ◯ | ◯ | ◯ | ◯ | Δ | ◯ | ◯ |
| Appearance of synthetic leather | ◯ | ◯ | ◯ | ◯ | ◯ | ◯ | X | ◯ |
| Wear resistance | ◯ | ◯ | ◯ | ◯ | ◯ | ◯ | ◯ | ◯ |
| Low temperature storage stability | ◯ | ◯ | Δ | Δ | Δ | X | ◯ | Δ |
| Cold-resistant flexibility | ◯ | ◯ | Δ | X | X | X | Δ | ◯ |
| Washing resistance | ◯ | ◯ | X | Δ | X | Δ | Δ | X |
| Adhesiveness (peel strength (N/25 | 17 | 15 | 15 | 7 | 13 | 10 | 13 | 15 |
| mm) between polyurethane layer | | | | | | | | |
| and base fabric) | | | | | | | | |
| Hydrolysis resistance | ◯ | ◯ | X | X | X | ◯ | X | X |

The present application is based on Japanese Patent Application (Japanese Patent Application No. 2021-180342) filed on Nov. 4, 2021, and the content of which is herein incorporated as reference.

### INDUSTRIAL APPLICABILITY

A polyurethane using the polyester polycarbonate polyol of the present invention has excellent balance of flexibility, chemical resistance, low-temperature characteristics, heat resistance, hydrolysis resistance, adhesiveness, wear resistance, texture and appearance, and thus can be suitably used particularly as a constituent material for synthetic leather or artificial leather. The synthetic leather or the artificial leather can also be suitably used for, for example, an automobile sheet where durability is required.

The polyester polycarbonate polyol of the present invention is also used in an adhesive for laminate welding of various films, a surface protection agent for such films, and the like. In particular, a curable composition using the polyester polycarbonate polyol of the present invention is used in an adhesive, a coating agent, and the like for, for example, artificial leather where flexibility is required.

### REFERENCE SIGNS LIST

1 release paper
2 skin layer
3 adhesion layer
4 base material (non-woven fabric)
5 mixing head (skin layer)
6 mixing head (adhesion layer)
7 sheet structure (dry synthetic leather product)
8 coating roll
9 pressure bonding roll
10 winding roll
11 drier

1. A polyester polycarbonate polyol comprising a repeating unit represented by the following formula (1) and a repeating unit represented by the following formula (2), having a hydroxyl value of 35 to 85 mgKOH/g, having a hydroxyl group at a terminal, and being in the form of a liquid at ordinary temperature: 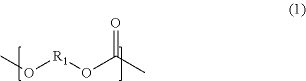
wherein R1 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, comprises at least one branch-containing alkylene group having 4 to 15 carbon atoms, and comprises at least one linear alkylene group having 2 to 10 carbon atoms; 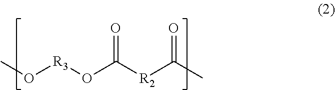
wherein R2 represents an alkylene group having 2 to 15 carbon atoms, and R3 is constituted from at least two selected from the group consisting of a linear alkylene group having 2 to 15 carbon atoms, a divalent alicyclic hydrocarbon group having 3 to 15 carbon atoms and a branch-containing alkylene group having 4 to 15 carbon atoms, comprises at least one branch-containing alkylene group having 4 to 15 carbon atoms, and comprises at least one linear alkylene group having 2 to 10 carbon atoms.

2. The polyester polycarbonate polyol according to claim 1, wherein a molar ratio (formula (1)/formula (2)) between a content rate of the repeating unit represented by the formula (1) and a content rate of the repeating unit represented by the formula (2) is 30/70 to 90/10.

3. The polyester polycarbonate polyol according to claim 1, wherein R1 in the formula (1) and/or R3 in the formula (2) comprise(s) at least one selected from the group consisting of a branch-containing alkylene group having 4 to 15 carbon atoms and at least two selected from the group consisting of a linear alkylene group having 2 to 10 carbon atoms.

4. The polyester polycarbonate polyol according to claim 1, wherein a viscosity measured at 50° C. with a rotatory viscometer is 1000 to 10000 mPa·s.

5. The polyester polycarbonate polyol according to claim 1, wherein the repeating unit represented by the formula (1) comprises 50% by mol or more of at least two repeating units selected from the group consisting of a repeating unit represented by the following formula (3), a repeating unit represented by the following formula (4), a repeating unit represented by the following formula (5), a repeating unit represented by the following formula (6) and a repeating unit represented by the following formula (7):

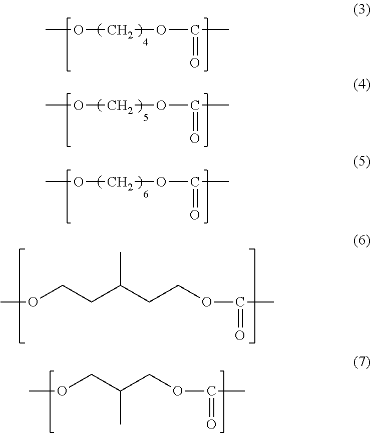

6. The polyester polycarbonate polyol according to claim 1, wherein a raw material used in the polyol is a bio-derived raw material.

7. A curable composition produced by using the polyester polycarbonate polyol according to claim 1 and reacting the same with an organic diisocyanate and a chain elongating agent.

8. Synthetic leather produced by using the polyester polycarbonate polyol according to claim 1.

9. An aqueous polyurethane produced by using the polyester polycarbonate polyol according to claim 1.

10. The polyester polycarbonate polyol according to claim 2, wherein R1 in the formula (1) and/or R3 in the formula (2) comprise(s) at least one selected from the group consisting of a branch-containing alkylene group having 4 to 15 carbon atoms and at least two selected from the group consisting of a linear alkylene group having 2 to 10 carbon atoms.

11. The polyester polycarbonate polyol according to claim 2, wherein a viscosity measured at 50° C. with a rotatory viscometer is 1000 to 10000 mPa·s.

12. The polyester polycarbonate polyol according to claim 2, wherein the repeating unit represented by the formula (1) comprises 50% by mol or more of at least two repeating units selected from the group consisting of a repeating unit represented by the following formula (3), a repeating unit represented by the following formula (4), a repeating unit represented by the following formula (5), a repeating unit represented by the following formula (6) and a repeating unit represented by the following formula (7):

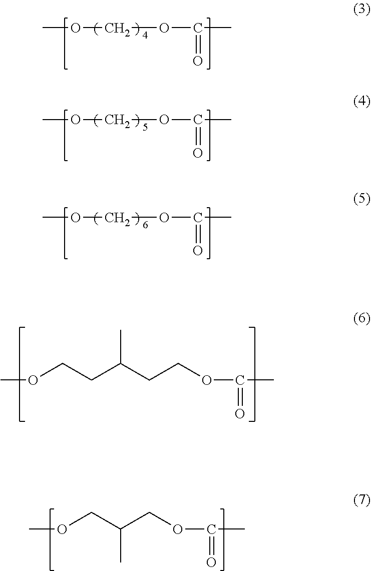

13. The polyester polycarbonate polyol according to claim 2, wherein a raw material used in the polyol is a bio-derived raw material.

14. A curable composition produced by using the polyester polycarbonate polyol according to claim 2 and reacting the same with an organic diisocyanate and a chain elongating agent.

15. Synthetic leather produced by using the polyester polycarbonate polyol according to claim 2.

16. An aqueous polyurethane produced by using the polyester polycarbonate polyol according to claim 2.

17. The polyester polycarbonate polyol according to claim 3, wherein a viscosity measured at 50° C. with a rotatory viscometer is 1000 to 10000 mPa·s.

18. The polyester polycarbonate polyol according to claim 3, wherein the repeating unit represented by the formula (1) comprises 50% by mol or more of at least two repeating units selected from the group consisting of a repeating unit represented by the following formula (3), a repeating unit represented by the following formula (4), a repeating unit represented by the following formula (5), a repeating unit represented by the following formula (6) and a repeating unit represented by the following formula (7):

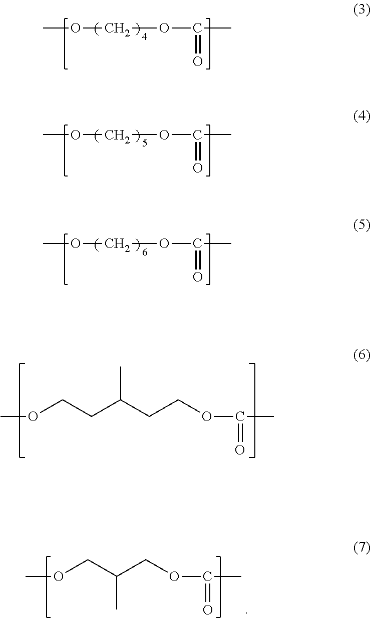

19. The polyester polycarbonate polyol according to claim 3, wherein a raw material used in the polyol is a bio-derived raw material.

20. A curable composition produced by using the polyester polycarbonate polyol according to claim 3 and reacting the same with an organic diisocyanate and a chain elongating agent.
